(19) United States
(12) Patent Application Publication
(10) Pub. No.: US 2026/0162897 A1
(43) Pub. Date: Jun. 11, 2026

(54) MULTILAYER CERAMIC ELECTRONIC COMPONENT

(71) Applicant: Murata Manufacturing Co., Ltd., Nagaokakyo-shi (JP)

(72) Inventors: Masahiro SAKURATANI, Nagaokakyo-shi (JP); Tomohiro SASAKI, Nagaokakyo-shi (JP)

(21) Appl. No.: 19/537,827

(22) Filed: Feb. 12, 2026

Related U.S. Application Data
(63) Continuation of application No. PCT/JP2024/013807, filed on Apr. 3, 2024.

(30) Foreign Application Priority Data
Aug. 28, 2023 (JP) 2023-138036

(51) Int. Cl. H01G 4/12; H01G 4/242; H01G 4/30

(52) U.S. Cl. CPC H01G 4/1227; H01G 4/242; H01G 4/30

(57) ABSTRACT

A multilayer ceramic electronic component includes a multilayer ceramic capacitor and a conductor section. The multilayer ceramic capacitor includes a laminate including dielectric layers stacked on one another, first and second principal surfaces, first and second side surfaces, and first and second end surfaces, first and second internal electrode layers each exposed at the first and second end surfaces, first and second external electrodes connected to the first internal electrode layer, and third and fourth external electrodes connected to the second internal electrode layer. The conductor section is electrically connected to the first and second external electrodes and is not electrically connected to the third and fourth external electrodes. A DC resistance of the conductor section is smaller than a DC resistance of the multilayer ceramic capacitor, and the conductor section includes a lead frame.

### CROSS REFERENCE TO RELATED APPLICATIONS

This application claims the benefit of priority to Japanese Patent Application No. 2023-138036 filed on Aug. 28, 2023 and is a Continuation Application of PCT Application No. PCT/JP2024/013807 filed on Apr. 3, 2024. The entire contents of each application are hereby incorporated herein by reference.

### BACKGROUND OF THE INVENTION

### 1. Field of the Invention

The present invention relates to multilayer ceramic electronic components.

### 2. Description of the Related Art

For example, as decoupling capacitors used to stabilize a power supply voltage supplied to an integrated circuit component (IC) that operates at high speed, and as noise countermeasure components of a power supply line supplied to an integrated circuit component (IC), feedthrough three-terminal capacitors have been known. Such feedthrough three-terminal capacitors each generally includes a multilayer body including a first main surface and a second main surface opposed to each other, a first lateral surface and a second lateral surface opposed to each other, and a first end surface and a second end surface opposed to each other. The multilayer body includes a plurality of first internal electrode layers and a plurality of second internal electrode layers alternately provided in the lamination direction therein. The plurality of first internal electrode layers each include two ends respectively extending toward the first end surface and the second end surface, and the plurality of second internal electrode layers each include two ends respectively extending toward the first lateral surface and the second lateral surface. Further, the plurality of first internal electrode layers are each connected to a first external electrode and a second external electrode, and the plurality of second internal electrode layers are each connected to a third external electrode and a fourth external electrode.

When a general feedthrough three-terminal capacitor is used as a noise filter, a DC current flows through the signal internal electrode (first internal electrode layer). However, when the capacitance becomes low, the number of signal internal electrodes (first internal electrode layers) becomes fewer and DC resistance increases. This causes a problem in that the heat generated from the capacitor increases.

In this regard, a configuration disclosed in Japanese Unexamined Patent Application Publication No. H9-55335 is provided as a configuration of a low-capacitance feedthrough three-terminal capacitor which is able to reduce or prevent an increase in DC resistance, while reducing or preventing an increase in electrostatic capacitance. When the number of signal internal electrodes (first internal electrode layers) is increased and the signal internal electrodes (first internal electrode layers) are opposed to each other, both of the electrostatic capacitance and the DC resistance are reduced or prevented.

However, such a configuration disclosed in Japanese Unexamined Patent Application Publication No. H9-55335 has the following problem. That is, there is a limitation in increasing the number of signal internal electrodes (first internal electrode layers) within a predetermined size constraint, and it is difficult to handle further large current. Further, it is necessary to design the internal structure uniquely for each capacitance, and the developability of the product lineup is poor.

### SUMMARY OF THE INVENTION

Example embodiments of the present invention provide multilayer ceramic electronic components that each do not require designing an internal structure for each capacitance, while reducing or prevent an increase in capacitance and an increase in DC resistance.

A multilayer ceramic electronic component according to an example embodiment of the present invention includes a multilayer ceramic capacitor including a multilayer body including a plurality of dielectric layers that are laminated, a first main surface and a second main surface opposed to each other in a lamination direction, a first lateral surface and a second lateral surface opposed to each other in a width direction orthogonal or substantially orthogonal to the lamination direction, a first end surface and a second end surface opposed to each other in a length direction orthogonal or substantially orthogonal to the lamination direction and the width direction, first internal electrode layers each exposed at the first end surface and the second end surface, and second internal electrode layers each exposed at the first lateral surface and the second lateral surface, a first external electrode and a second external electrode connected to the first internal electrode layers, and a third external electrode and a fourth external electrode connected to the second internal electrode layers, and a conductor portion electrically connected to the first external electrode and the second external electrode, and not electrically connected to the third external electrode and the fourth external electrode, in which a DC resistance of the conductor portion is smaller than a DC resistance of the multilayer ceramic capacitor, and the conductor portion includes a lead frame.

In a multilayer ceramic electronic component according to an example embodiment of the present invention, the DC resistance of the conductor portion connected to the multilayer ceramic capacitor is smaller than the DC resistance of the multilayer ceramic capacitor. This allows DC current to flow through the conductor portion and AC current to flow to the multilayer ceramic capacitor. More specifically, since DC current easily flows toward the side having lower DC resistance, it is likely to flow toward the conductor portion having lower DC resistance than toward the multilayer ceramic capacitor. On the other hand, since AC current easily flows toward the side having lower impedance, it is likely to flow toward the multilayer ceramic capacitor having low impedance. With such a configuration, it is possible to reduce or prevent an increase in capacitance and an increase in DC resistance of the multilayer ceramic capacitor. Further, it is possible to handle large current by simply attaching the conductor portion to an existing multilayer ceramic capacitor without newly designing the internal structure uniquely for each capacitance of the multilayer ceramic capacitor. This also improves the developability of the product lineup.

According to example embodiments of the present invention, it is possible to provide multilayer ceramic electronic components each with mounting structures that are each able to reduce or prevent an increase in capacitance and an increase in direct current resistance, while eliminating the need to design an internal configuration for each capacitance.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view showing a multilayer ceramic electronic component according to a first example embodiment of the present invention.

FIG. 2 is a front view of the multilayer ceramic electronic component according to the first example embodiment of the present invention.

FIG. 3 is a plan view of the multilayer ceramic electronic component according to the first example embodiment of the present invention.

FIG. 4 is a perspective view of a multilayer ceramic capacitor according to the first example embodiment of the present invention.

FIG. 5 is a front view of the multilayer ceramic capacitor according to the first example embodiment of the present invention.

FIG. 6 is a plan view of the multilayer ceramic capacitor according to the first example embodiment of the present invention.

FIG. 7 is a cross-sectional view taken along the line VII-VII of FIG. 4.

FIG. 8 is a cross-sectional view taken along the line VIII-VIII of FIG. 4.

FIG. 9 is a cross-sectional view taken along the line IX-IX of FIG. 7.

FIG. 10 is a cross-sectional view taken along the line X-X of FIG. 7.

FIG. 11 is a cross-sectional view in the lamination direction showing a mounting structure of the multilayer ceramic electronic component according to the first example embodiment of the present invention.

FIG. 12 is a cross-sectional view in the width direction showing a mounting structure of the multilayer ceramic electronic component according to the first example embodiment of the present invention.

FIG. 13 is a cross-sectional view showing a first modified example of the multilayer ceramic capacitor according to the first example embodiment of the present invention, corresponding to the cross-sectional view of FIG. 7.

FIG. 14 is a cross-sectional view showing the first modified example of the multilayer ceramic capacitor according to the first example embodiment of the present invention, corresponding to the cross-sectional view of FIG. 8.

FIG. 15 is a cross-sectional view taken along the line XV-XV of FIG. 13.

FIG. 16 is a cross-sectional view taken along the line XVI-XVI of FIG. 13.

FIG. 17 is a cross-sectional view showing a second modified example of the multilayer ceramic capacitor according to the first example embodiment of the present invention, corresponding to the cross-sectional view of FIG. 7.

FIG. 18 is a cross-sectional view showing the second modified example of the multilayer ceramic capacitor according to the first example embodiment of the present invention, corresponding to the cross-sectional view of FIG. 8.

FIG. 19 is an external perspective view showing a multilayer ceramic electronic component according to a second example embodiment of the present invention.

FIG. 20 is a front view of the multilayer ceramic electronic component according to the second example embodiment of the present invention.

FIG. 21 is a plan view of the multilayer ceramic electronic component according to the second example embodiment of the present invention.

### DETAILED DESCRIPTION OF THE EXAMPLE EMBODIMENTS

Example embodiments of the present invention will be described in detail below with reference to the drawings.

A multilayer ceramic electronic component 100 according to a first example embodiment of the present invention will be described.

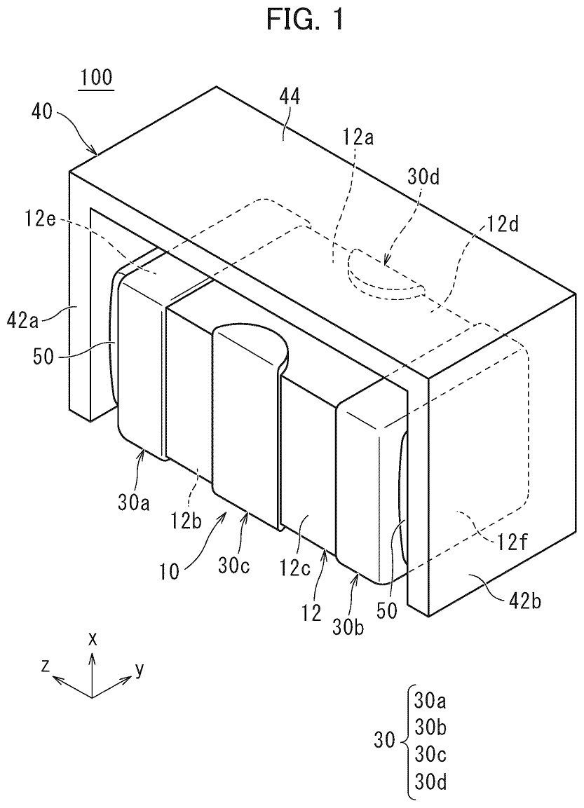

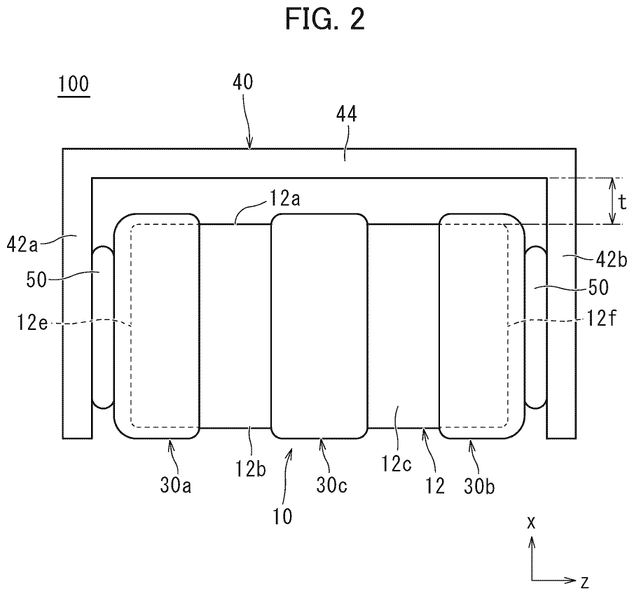

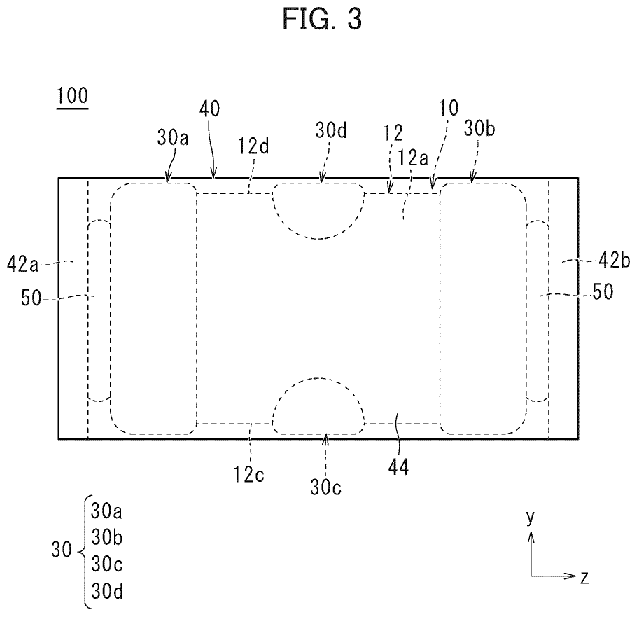

FIG. 1 is an external perspective view showing a multilayer ceramic electronic component according to a first example embodiment of the present invention. FIG. 2 is a front view of the multilayer ceramic electronic component according to the first example embodiment of the present invention. FIG. 3 is a plan view of the multilayer ceramic electronic component according to the first example embodiment of the present invention.

As shown in FIGS. 1 to 3, the multilayer ceramic electronic component 100 according to the first example embodiment of the present invention includes a multilayer ceramic capacitor 10 and a conductor portion 40.

A multilayer ceramic capacitor 10 according to the first example embodiment of the present invention will be described.

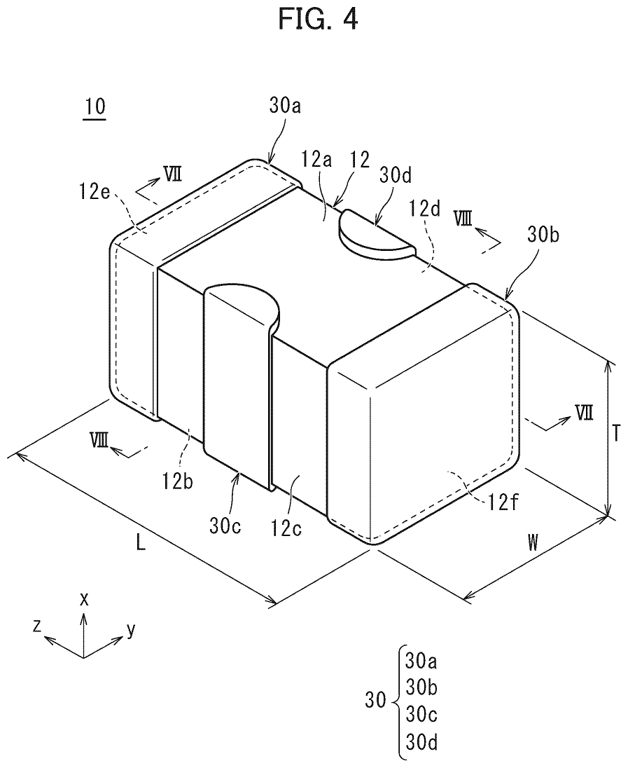

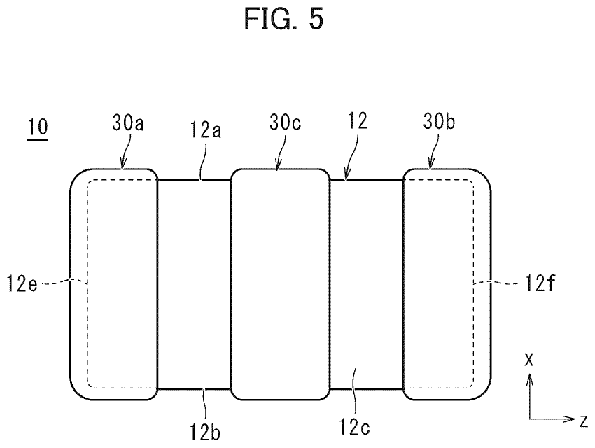

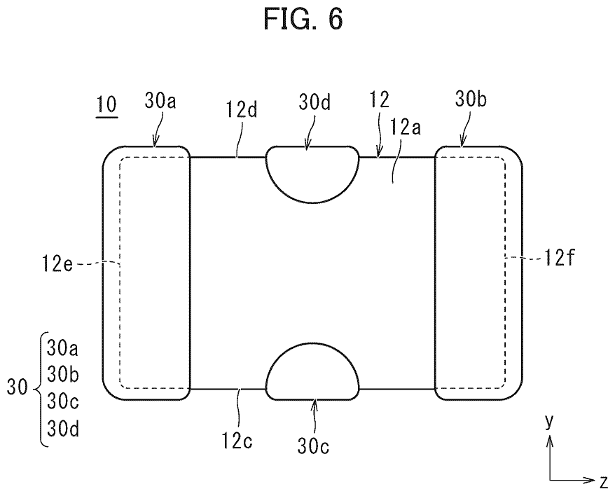

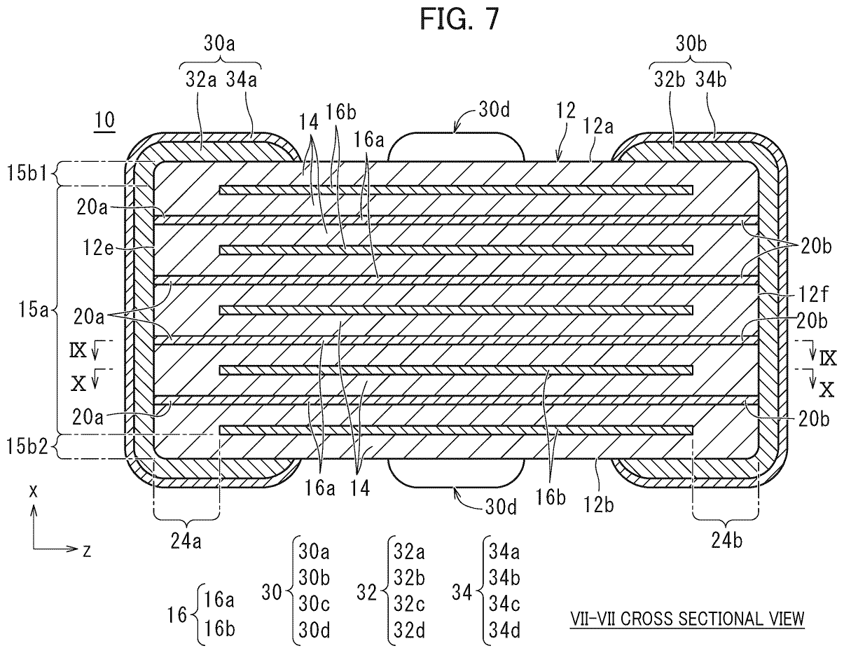

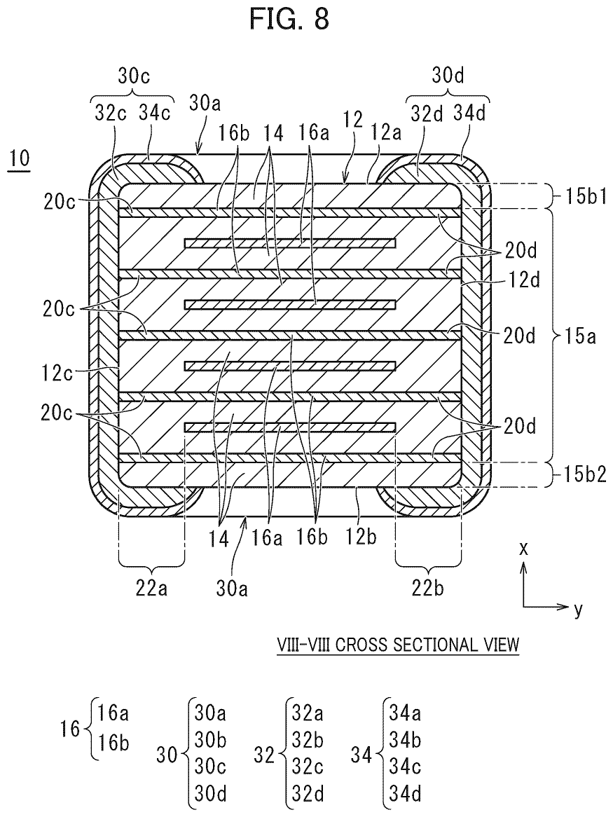

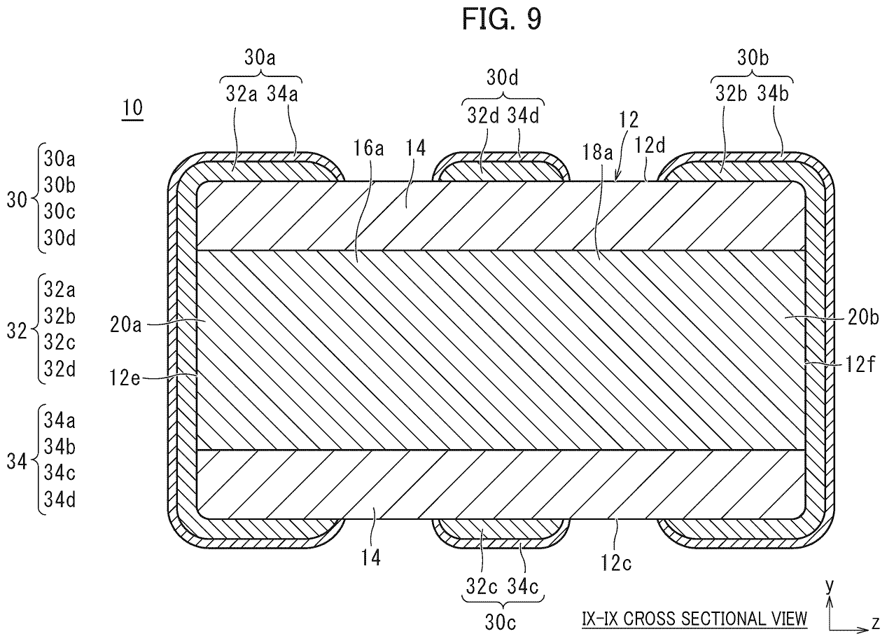

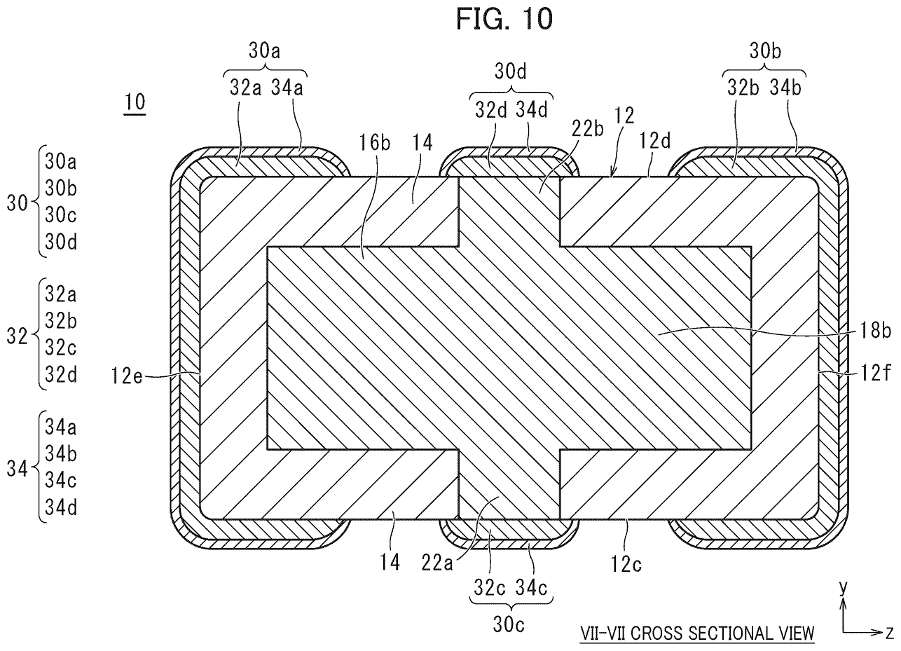

FIG. 4 is a perspective view of the multilayer ceramic capacitor according to the first example embodiment of the present invention. FIG. 5 is a front view of the multilayer ceramic capacitor according to the first example embodiment of the present invention. FIG. 6 is a plan view of the multilayer ceramic capacitor according to the first example embodiment of the present invention. FIG. 7 is a cross-sectional view taken along the line VII-VII of FIG. 4. FIG. 8 is a cross-sectional view taken along the line VIII-VIII of FIG. 4. FIG. 9 is a cross-sectional view taken along the line IX-IX of FIG. 7. FIG. 10 is a cross-sectional view taken along the line X-X of FIG. 7.

The multilayer ceramic capacitor 10 includes a multilayer body 12 and external electrodes 30. Hereinafter, the configurations of the multilayer body 12 and the external electrodes 30 will be described in order.

The multilayer body 12 includes a plurality of laminated dielectric layers 14. Further, the multilayer body 12 includes a first main surface 12a and a second main surface 12b opposed to each other in the lamination direction x, a first lateral surface 12c and a second lateral surface 12d opposed to each other in the width direction y orthogonal or substantially orthogonal to the lamination direction x, and a first end surface 12e and a second end surface 12f opposed to each other in the length direction z orthogonal or substantially orthogonal to the lamination direction x and the width direction y. The multilayer body 12 has a rectangular or substantially rectangular parallelepiped shape. Further, it is preferred that the multilayer body 12 includes rounded corner portions and ridge portions. The corner portions refer to portions where three adjacent surfaces of the multilayer body 12 intersect, and the ridge portions refer to portions where two adjacent surfaces of the multilayer body 12 intersect. Further, irregularities may be provided on a portion or all of the first main surface 12a and the second main surface 12b, a portion or all of the first lateral surface 12c and the second lateral surface 12d, and a portion or all of the first end surface 12e and the second end surface 12f.

As shown in FIGS. 3 to 9, the multilayer body 12 includes an inner layer portion 15a in which a plurality of internal electrode layers 16 are alternately provided with a corresponding one of the dielectric layers 14 interposed therebetween, a first outer layer portion 15b1 located adjacent to the first main surface 12a and including a plurality of dielectric layers 14 located between the first main surface 12a and an outermost surface of the inner layer portion 15a adjacent to the first main surface 12a, and a second outer layer portion 15b2 located adjacent to the second main surface 12b and including a plurality of dielectric layers 14 located between the second main surface 12b and an outermost surface of the inner layer portion 15a adjacent to the second main surface 12b.

Here, the plurality of dielectric layers 14 for the inner layer of the inner layer portion 15a are sandwiched between first internal electrode layers 16a and second internal electrode layers 16b described later.

The number of the laminated dielectric layers 14 is not particularly limited, but is preferably, for example, 10 or more and 1000 or less including those in the first outer layer portion 15b1 and the second outer layer portion 15b2. Further, the thickness of each of the dielectric layers 14 is preferably, for example, about 0.5 μm or more and about 15 μm or less.

Each of the dielectric layers 14 can be made of a dielectric material, for example, as a ceramic material. As such a dielectric material, for example, a dielectric ceramic containing components such as BaTiO₃, CaTiO3, SrTiO₃, or CaZrO₃ can be used. In addition, in a case where such a dielectric material is included as a main component, a subcomponent having a content smaller than that of the main component, such as, for example, a Mn compound, a Fe compound, a Cr compound, a Co compound, or a Ni compound, may be added according to the desired characteristics of the multilayer body 12.

Further, each of the dielectric layers 14 may include a plurality of crystal grains including a perovskite compound including BaTiO₃ as a basic structure, for example. The size of the crystal grains is appropriately designed according to the thickness of each of the dielectric layers 14. In the case of the present example embodiment, the capacitance of a capacitor is larger as each of the dielectric layers 14 is thinner and, therefore, the crystal grain size is preferably, for example, about 1 μm or less.

Further, the dielectric layers 14 for the outer layer of the first outer layer portion 15b1 and the second outer layer portion 15b2 are made of the same dielectric ceramic material as the dielectric layer 14 of the inner layer portion 15a. In addition, the dielectric layers 14 in the first outer layer portion 15b1 and the second outer layer portion 15b2 may be made of a material different from that of the dielectric layers 14 in the inner layer portion 15a. In addition, each of the dielectric layers 14 in the first outer layer portion 15b1 and the second outer layer portion 15b2 may include a multilayer configuration or a single layer configuration. Further, in a case in which the dielectric layers 14 of the first outer layer portion 15b1 and the second outer layer portion 15b2 each include a multilayer configuration, it is preferred that segregation portions of Si in the dielectric layers 14 in the first outer layer portion 15b1 and the second outer layer portion 15b2 respectively located closest to the first internal electrode layer 16a and the second internal electrode layer 16b are less than segregation portions of Si in the other dielectric layers 14 in the first outer layer portion 15b1 and the second outer layer portion 15b2. This can improve the flexural strength of the multilayer ceramic capacitor 10 from the lamination direction x.

The multilayer body 12 includes side portions 22a and 22b (hereinafter, each referred to as a “W gap”) of the multilayer body 12 located between the first internal electrode layers 16a and the first lateral surface 12c, and between the first internal electrode layers 16a and the second lateral surface 12d.

Further, the multilayer body 12 includes end portions 24a and 24b (hereinafter, each referred to as an “L gap”) of the multilayer body 12 located between the second internal electrode layers 16b and the first end surface 12e, and between the second internal electrode layers 16b and the second end surface 12f.

The internal electrode layers 16 include, as shown in FIGS. 7 to 10, first internal electrode layers 16a each exposed at the first end surface 12e and the second end surface 12f, and second internal electrode layers 16b each exposed at the first lateral surface 12c and the second lateral surface 12d.

The first internal electrode layers 16a each include a first counter electrode portion 18a opposed to the second internal electrode layers 16b, a first extension electrode portion 20a provided at one end of the first internal electrode layer 16a and extending from the first counter electrode portion 18a toward the first end surface 12e of the multilayer body 12, and a second extension electrode portion 20b provided at one end of the first internal electrode layer 16a and extending from the first counter electrode portion 18a toward the second end surface 12f of the multilayer body 12.

The second internal electrode layers 16b each include a second counter electrode portion 18b opposed to the first internal electrode layers 16a, a third extension electrode portion 20c provided at one end of the second internal electrode layer 16b and extending from the second counter electrode portion 18b toward the first lateral surface 12c of the multilayer body 12, and a fourth extension electrode portion 20d provided at one end of the second internal electrode layer 16b and extending from the second counter electrode portion 18b toward the second lateral surface 12d of the multilayer body 12.

The shape of the first counter electrode portion 18a of each of the first internal electrode layers 16a is not particularly limited, but is preferably rectangular or substantially rectangular in a plan view. However, corner portions in a plan view may be rounded, or corner portions may be obliquely shaped (tapered) in a plan view. Each of the first counter electrode portions 18a may also have a tapered shape in a plan view that is sloped toward either direction.

The shape of the second counter electrode portion 18b of each of the second internal electrode layers 16b is not particularly limited, but is preferably rectangular or substantially rectangular in a plan view. However, corner portions in a plan view may be rounded, or corner portions may be obliquely shaped (tapered) in a plan view. The second counter electrode portion 18b may also have a tapered shape in a plan view that is sloped toward either direction.

The shapes of the first extension electrode portion 20a and the second extension electrode portion 20b of each of the first internal electrode layers 16a are not particularly limited, but are preferably rectangular or substantially rectangular in a plan view. However, corner portions in a plan view may be rounded, or corner portions may be obliquely shaped (tapered) in a plan view. Each of the first extension electrode portion 20a and the second extension electrode portion 20b may also have a tapered shape in a plan view that is sloped toward either direction.

The shapes of the third extension electrode portion 20c and the fourth extension electrode portion 20d of each of the second internal electrode layers 16b are not particularly limited, but are preferably rectangular or substantially rectangular in a plan view. However, corner portions in a plan view may be rounded, or corner portions may be obliquely shaped (tapered) in a plan view. Each of the third extension electrode portion 20c and the fourth extension electrode portion 20d may also have a tapered shape in a plan view that is sloped toward either direction.

The width of the first counter electrode portion 18a of each of the first internal electrode layers 16a and the widths of the first extension electrode portion 20a and the second extension electrode portion 20b of each of the first internal electrode layers 16a may be the same, or either one may have a narrower width than the other.

The width of the second counter electrode portion 18b of each of the second internal electrode layers 16b and the widths of the third extension electrode portion 20c and the fourth extension electrode portion 20d of each of the second internal electrode layers 16b may be the same, or either one may have a narrower width than the other.

In the present example embodiment, the widths in the length direction z of the third extension electrode portion 20c and the fourth extension electrode portion 20d of the second internal electrode layer 16b are narrower than the width in the length direction z of the second counter electrode portion 18b of the second internal electrode layer 16b.

The first internal electrode layers 16a each preferably have a uniform thickness, but the thickness of the edge portion of each of the first internal electrode layers 16a may be greater than the thickness of the middle portion thereof. When the thickness of the edge portion of each of the first internal electrode layers 16a is increased, coverage is improved. Therefore, the current path becomes shorter, and ESL characteristics are improved. The thickness of the edge portion of each of the first internal electrode layers 16a may also be smaller than the thickness of the middle portion thereof. With such a configuration, a step difference corresponding to the thickness of the first internal electrode layer 16a is reduced, which leads to reduction or prevention of structural defects.

The first internal electrode layers 16a and the second internal electrode layers 16b may each include an appropriate electrically conductive material, such as metals such as, for example, Ni, Cu, Ag, Pd, or Au, or alloys including at least one of these metals, such as an Ag-Pd alloy, but are not limited thereto.

In the present example embodiment, the first counter electrode portion 18a of each of the first internal electrode layers 16a and the second counter electrode portion 18b of each of the second internal electrode layers 16b are opposed to each other with a corresponding one of the dielectric layers 14 interposed therebetween, such that capacitance is generated and capacitor characteristics are provided.

The thickness of each of the first internal electrode layers 16a and the second internal electrode layers 16b is preferably, for example, about 0.5 μm or more and about 1.5 μm or less. The number of laminated first internal electrode layers 16a and second internal electrode layers 16b is appropriately changed according to the size or the like. When the number of the first internal electrode layers 16a increases, an increase in DC resistance can be reduced or prevented. The total number of the first internal electrode layers 16a and the second internal electrode layers 16b is preferably, for example, 10 or more and 1000 or less.

The first extension electrode portion 20a and the second extension electrode portion 20b of each of the first internal electrode layers 16a may be curved. The third extension electrode portion 20c and the fourth extension electrode portion 20d of each of the second internal electrode layers 16b may also be curved. At this time, they may be curved toward either one of the first main surface 12a or the second main surface 12b. In this case, it is possible to shorten the current path by configuring the mounting surface as the curved surface.

The distance between the first internal electrode layer 16a closest to the first main surface 12a and the first internal electrode layer 16a closest to the second main surface 12b among the first internal electrode layers 16a extending toward and exposed on the first end surface 12e and the second end surface 12f may be shorter than the distance between the first counter electrode portion 18a of the first internal electrode layer 16a closest to the first main surface 12a and the first counter electrode portion 18a of the first internal electrode layer 16a closest to the second main surface 12b.

The distance between the second internal electrode layer 16b closest to the first main surface 12a and the second internal electrode layer 16b closest to the second main surface 12b among the second internal electrode layers 16b each extending toward and exposed on the first lateral surface 12c and the second lateral surface 12d may be shorter than the distance between the second counter electrode portion 18b of the second internal electrode layer 16b closest to the first main surface 12a and the second counter electrode portion 18b of the second internal electrode layer 16b closest to the second main surface 12b.

In order to increase the capacitance of the capacitor, it is necessary to increase the area of each of the internal electrode layers 16. Therefore, the LW surface coverage of each of the internal electrode layers 16 is preferably, for example, about 90% or more. Here, the LW surface coverage of each of the internal electrode layers 16 is defined as a ratio obtained by subtracting the area of gaps from the area inside the edge portions of each of the internal electrode layers 16 when viewed from the LW surface of the multilayer body 12. When the LW surface coverage of each of the internal electrode layers 16 is higher, the capacitance of the capacitor is higher. However, even when the LW surface coverage is low, since the dielectric layers 14 are bonded to each other via gaps, the bonding strength between layers is high, and interlayer peeling is less likely to occur.

The external electrodes 30 include a first external electrode 30a, a second external electrode 30b, a third external electrode 30c, and a fourth external electrode 30d.

The first external electrode 30a is connected to the first internal electrode layers 16a and provided on the first end surface 12e. Further, the first external electrode 30a extends around a portion of the first main surface 12a and a portion of the second main surface 12b. In addition, it is preferable that the first external electrode 30a extends from the first end surface 12e slightly around a portion of the first lateral surface 12c and a portion of the second lateral surface 12d.

The second external electrode 30b is connected to the first internal electrode layers 16a and provided on the second end surface 12f. Further, the second external electrode 30b extends around a portion of the first main surface 12a and a portion of the second main surface 12b. In addition, it is preferable that the second external electrode 30b extends from the second end surface 12f slightly around a portion of the first lateral surface 12c and a portion of the second lateral surface 12d.

The third external electrode 30c is connected to the second internal electrode layers 16b and provided on the first lateral surface 12c. In addition, it is preferable that the third external electrode 30c is provided on a portion of the first main surface 12a and a portion of the second main surface 12b. In addition, the third external electrode 30c may be provided on one of a portion of the first main surface 12a or a portion of the second main surface 12b continuously from the first lateral surface 12c.

The fourth external electrode 30d is connected to the second internal electrode layers 16b and provided on the second lateral surface 12d. In addition, it is preferable that the fourth external electrode 30d is provided on a portion of the first main surface 12a and a portion of the second main surface 12b. In addition, the fourth external electrode 30d may be provided on one of a portion of the first main surface 12a or a portion of the second main surface 12b continuously from the second lateral surface 12d.

The third external electrode 30c and the fourth external electrode 30d may be directly bonded to each other.

The first external electrode 30a includes a first base electrode layer 32a including an electrically conductive metal provided on the multilayer body 12, and a first plated layer 34a that covers the first base electrode layer 32a. The second external electrode 30b includes a second base electrode layer 32b including an electrically conductive metal provided on the multilayer body 12, and a second plated layer 34b that covers the second base electrode layer 32b. The third external electrode 30c includes a third base electrode layer 32c including an electrically conductive metal provided on the multilayer body 12, and a third plated layer 34c that covers the third base electrode layer 32c. The fourth external electrode 30d includes a fourth base electrode layer 32d including an electrically conductive metal provided on the multilayer body 12, and a fourth plated layer 34d that covers the fourth base electrode layer 32d.

The base electrode layer 32 includes a first base electrode layer 32a, a second base electrode layer 32b, a third base electrode layer 32c, and a fourth base electrode layer 32d. The first base electrode layer 32a, the second base electrode layer 32b, the third base electrode layer 32c, and the fourth base electrode layer 32d include at least one of, for example, a fired layer, an electrically conductive resin layer, a thin film layer, or the like.

The fired layer includes a glass component and a metal. The fired layer may include a plurality of layers.

The glass component of the fired layer includes at least one of, for example, B, Si, Ba, Mg, Al, Li, or the like.

The metal of the fired layer includes, for example, at least one of Cu, Ni, Ag, Pd, an Ag-Pd alloy, Au, or the like.

The fired layer is formed by applying an electrically conductive paste including glass and metal to the multilayer body 12 and firing the paste, and may be formed by cofiring the paste with the internal electrode layers 16, or may be formed by firing the paste after firing the internal electrode layers 16.

In a case in which a fired layer is provided as the first base electrode layer 32a and the second base electrode layer 32b, the thickness of the fired layer in the middle portion in the lamination direction x of each of the first base electrode layer 32a and the second base electrode layer 32b respectively located on the first end surface 12e and the second end surface 12f is preferably, for example, about 20 μm or more and about 50 μm or less.

In addition, in a case in which a fired layer is provided as the first base electrode layer 32a and the second base electrode layer 32b on the first main surface 12a, the second main surface 12b, the first lateral surface 12c, and the second lateral surface 12d, it is preferred that the thickness of the fired layer in the middle portion in the length direction z of each of the first base electrode layer 32a and the second base electrode layer 32b respectively located on the first main surface 12a, the second main surface 12b, the first lateral surface 12c, and the second lateral surface 12d is, for example, about 5 μm or more and about 20 μm or less.

In a case in which a fired layer is provided as the third base electrode layer 32c and the fourth base electrode layer 32d, the thickness of the fired layer in the middle portion in the lamination direction x of each of the third base electrode layer 32c and the fourth base electrode layer 32d respectively located on the first lateral surface 12c and the second lateral surface 12d is preferably, for example, about 20 μm or more and about 50 μm or less.

In addition, in a case in which a fired layer is provided as the third base electrode layer 32c and the fourth base electrode layer 32d on the first main surface 12a and the second main surface 12b, it is preferred that the thickness of the fired layer in the middle portion in the width direction y of each of the third base electrode layer 32c and the fourth base electrode layer 32d respectively located on the first main surface 12a and the second main surface 12b is, for example, about 5 μm or more and about 20 μm or less.

Next, a case where the base electrode layer 32 includes an electrically conductive resin layer will be described. The electrically conductive resin layer may be provided on the fired layer to cover the fired layer, or may be provided directly on the multilayer body 12 without providing the fired layer. Further, the electrically conductive resin layer may completely cover the fired layer or may partially cover the fired layer. Further, the electrically conductive resin layer may include a plurality of layers.

The electrically conductive resin layer includes a thermosetting resin and a metal. Since the electrically conductive resin layer includes a thermosetting resin, the electrically conductive resin layer is more flexible than a fired layer made of, for example, a plated film or a fired product of an electrically conductive paste. For this reason, even when a physical shock or a shock due to thermal cycling is applied to the multilayer ceramic capacitor 10, the electrically conductive resin layer defines and functions as a buffer layer, so that cracks in the multilayer ceramic capacitor 10 can be prevented.

As the metal included in the electrically conductive resin layer, for example, Ag, Cu, Ni, Sn, Bi, or an alloy including them can be used. Alternatively, for example, a metal powder obtained by coating the surface of the metal powder with Ag may be used. When an Ag-coated metal powder is used, for example, Cu, Ni, Sn, Bi or an alloy powder thereof is preferably used as the metal powder. The reason why the electrically conductive metal powder of Ag is used as the electrically conductive metal is that Ag is suitable for an electrode material because Ag has the lowest specific resistance among metals, Ag is a noble metal, and thus does not oxidize and has high weather resistance. The reason why the Ag-coated metal is used is that the metal of the base material can be made inexpensively, while maintaining the above-described characteristics of Ag.

The metal included in the electrically conductive resin layer mainly provides electrical conductivity to the electrically conductive resin layer. Specifically, the metals (electrically conductive filler) included in the electrically conductive resin layer come into contact with each other to provide an electrical conduction path in the electrically conductive resin layer.

As the metal included in the electrically conductive resin layer, for example, a metal having a spherical shape, a metal having a flat shape, or the like can be used, and it is preferable to use a mixture of a spherical metal powder and a flat metal powder. The average particle size of the metal included in the electrically conductive resin layer is not particularly limited. The average particle size of the metal (conductive filler) contained in the electrically conductive resin layer may be, for example, about 0.3 μm or more and about 10 μm or less.

The metal included in the electrically conductive resin layer is preferably included in an amount of, for example, about 35 vol % or more and about 75 vol % or less with respect to the total volume of the electrically conductive resin.

As the resin of the electrically conductive resin layer, for example, various known thermosetting resins such as, for example, an epoxy resin, a phenol resin, a urethane resin, a silicone resin, or a polyimide resin can be used. Among them, an epoxy resin excellent in heat resistance, moisture resistance, adhesion, and the like is one of the preferable resins.

The resin included in the electrically conductive resin layer is preferably included in an amount of, for example, about 25 vol % or more and about 65 vol % or less with respect to the total volume of the conductive resin.

The electrically conductive resin layer preferably includes a curing agent together with the thermosetting resin. As the curing agent, when an epoxy resin is used as the base resin, various known compounds such as, for example, phenol-based, amine-based, acid anhydride-based, imidazole-based, active ester-based, or amideimide-based compounds can be used as curing agents for the epoxy resin.

In a case in which the electrically conductive resin electrode layer is provided as the first base electrode layer 32a and the second base electrode layer 32b, the thickness of the conductive resin electrode layer in the middle portion in the lamination direction x of each of the first base electrode layer 32a and the second base electrode layer 32b respectively located on the first end surface 12e and the second end surface 12f is preferably, for example, about 20 μm or more and about 70 μm or less.

In addition, in a case in which the electrically conductive resin electrode layer is provided as the first base electrode layer 32a and the second base electrode layer 32b on the first main surface 12a, the second main surface 12b, the first lateral surface 12c, and the second lateral surface 12d, it is preferred that the thickness of the electrically conductive resin electrode layer in the middle portion in the length direction z of each of the first base electrode layer 32a and the second base electrode layer 32b respectively located on the first main surface 12a, the second main surface 12b, the first lateral surface 12c, and the second lateral surface 12d is, for example, about 5 μm or more and about 20 μm or less.

In a case in which the electrically conductive resin electrode layer is provided as the third base electrode layer 32c and the fourth base electrode layer 32d, it is preferred that the thickness of the electrically conductive resin electrode layer in the middle portion in the lamination direction x of each of the third base electrode layer 32c and the fourth base electrode layer 32d respectively located on the first lateral surface 12c and the second lateral surface 12d is, for example, about 20 μm or more and about 70 μm or less.

In addition, in a case in which the electrically conductive resin electrode layer is provided as the third base electrode layer 32c and the fourth base electrode layer 32d on the first main surface 12a and the second main surface 12b, it is preferred that the thickness of the electrically conductive resin electrode layer in the middle portion in the width direction y of each of the third base electrode layer 32c and the fourth base electrode layer 32d respectively located on the first main surface 12a and the second main surface 12b is, for example, about 5 μm or more and about 20 μm or less.

In addition, only the electrically conductive resin electrode layer may be provided as the first base electrode layer 32a and the second base electrode layer 32b, and only the electrically conductive resin electrode layer may be provided as the third base electrode layer 32c and the fourth base electrode layer 32d.

The plated layer 34 includes a first plated layer 34a, a second plated layer 34b, a third plated layer 34c, and a fourth plated layer 34d.

The first plated layer 34a covers the first base electrode layer 32a. The second plated layer 34b covers the second base electrode layer 32b. The third plated layer 34c covers the third base electrode layer 32c. The fourth plated layer 34d covers the fourth base electrode layer 32d.

The plated layer 34 includes, for example, at least one of Cu, Ni, Sn, Ag, Pd, an Ag—Pd alloy, Au, or the like.

The plated layer 34 may include a plurality of layers. The plated layer 34 preferably includes a two-layer configuration in the order of Ni plating and Sn plating, for example. The Ni plated layer can prevent the base electrode layer 32 from being eroded by solder when mounting the multilayer ceramic capacitor 10. In addition, the Sn plated layer improves the wettability of solder when mounting the multilayer ceramic capacitor 10, and thus can be easily mounted. When the plated layer 34 includes a three-layer configuration, for example, it is preferable to include Sn plating, Ni plating, and Sn plating in this order from the multilayer body 12.

The thickness of the plated layer 34 per layer is preferably, for example, about 1 μm or more and about 6 μm or less.

Any or each of the first external electrode 30a, the second external electrode 30b, the third external electrode 30c and the fourth external electrode 30d may include a plated layer provided directly on the surface of the multilayer body 12. That is, the multilayer ceramic capacitor 10 may include a configuration including a plated layer that is directly electrically connected to the first internal electrode layers 16a and the second internal electrode layers 16b. In such a case, a plated layer may be directly formed after the catalyst is provided on the surface of the multilayer body 12 as a pretreatment.

The first direct plated layer is provided on the first end surface 12e and is bonded to the first internal electrode layers 16a. The second direct plated layer is provided on the second end surface 12f and is bonded to the first internal electrode layers 16a. The third direct plated layer is provided on the first lateral surface 12c and is bonded to the second internal electrode layers 16b. The fourth direct plated layer is provided on the second lateral surface 12d and is bonded to the second internal electrode layers 16b.

Each of the direct plated layers preferably includes, for example, at least one metal selected from Cu, Ni, Sn, Pb, Au, Ag, Pd, Bi, and Zn, or an alloy containing the metal.

For example, in a case in which the first internal electrode layers 16a and the second internal electrode layers 16b are formed using Ni, the direct plated layer is preferably formed using Cu, which has a good bonding property with Ni.

In a case in which the plated layer 34 is directly provided on the multilayer body 12, the thickness of the plated layer 34 per layer is preferably, for example, about 1 μm or more and about 15 μm or less.

In a case in which the plated layer 34 is directly provided on the multilayer body 12, the plated layer 34 preferably does not include glass. Further, the metal ratio per unit volume of the plated layer 34 is preferably, for example, about 99% by volume or more.

A case where the base electrode layer 32 includes a thin film layer and the plated layer 34 is directly provided on the thin film layer will be described.

The first thin film layer provided on the first main surface 12a is connected to the first direct plated layer which extends around from the first end surface 12e. The second thin film layer provided on the first main surface 12a is connected to the second direct plated layer, which extends around from the second end surface 12f. The third thin film layer provided on the first main surface 12a is connected to the third direct plated layer, which extends around from the first lateral surface 12c. The fourth thin film layer provided on the first main surface 12a is connected to the fourth direct plated layer, which extends around from the second lateral surface 12d.

Similarly, the first thin film layer provided on the second main surface 12b is connected to the first direct plated layer, which extends around from the first end surface 12e. The second thin film layer provided on the second main surface 12b is connected to the second direct plated layer, which extends around from the second end surface 12f. The third thin film layer provided on the second main surface 12b is connected to the third direct plated layer, which extends around from the first lateral surface 12c. The fourth thin film layer provided on the second main surface 12b is connected to the fourth direct plated layer, which extends around from the second lateral surface 12d.

The dimension of the multilayer ceramic capacitor 10 including the multilayer body 12 and the external electrodes 30 in the length direction z is defined as an L dimension. The L dimension is preferably, for example, about 1.0 mm or more and about 3.2 mm or less. The dimension of the multilayer ceramic capacitor 10 including the multilayer body 12 and the external electrodes 30 in the lamination direction x is defined as a T dimension. The T dimension is preferably, for example, about 0.3 mm or more and about 2.5 mm or less. The dimension of the multilayer ceramic capacitor 10 including the multilayer body 12 and the external electrodes 30 in the width direction y is defined as a W dimension. The W dimension is preferably, for example, about 0.5 mm or more and about 2.5 mm or less.

Next, the conductor portion 40 will be described. The conductor portion 40 is electrically connected to each of the first external electrode 30a and the second external electrode 30b of the multilayer ceramic capacitor 10 via an electrically conductive bonding agent 50.

The conductor portion 40 is configured as, for example, a plate-shaped lead frame. The conductor portion 40 includes a first terminal bonding portion 42a connected to the first external electrode 30a, a second terminal bonding portion 42b connected to the second external electrode 30b, and a coupling portion 44 that extends from the first terminal bonding portion 42a in a direction connecting the first end surface 12e and the second end surface 12f on the side of the first main surface 12a of the multilayer body 12 and is connected to the second terminal bonding portion 42b.

The first terminal bonding portion 42a of the conductor portion 40 is a portion connected to the first external electrode 30a provided on the first end surface 12e of the multilayer body 12. The first terminal bonding portion 42a has a plate shape, and one main surface opposed to the first end surface 12e of the multilayer body 12 is connected to the first end surface 12e by the electrically conductive bonding agent 50. The shape of the first terminal bonding portion 42a is not particularly limited, but is preferably a rectangular or substantially rectangular shape.

The second terminal bonding portion 42b of the conductor portion 40 is a portion connected to the second external electrode 30b provided on the second end surface 12f of the multilayer body 12. The second terminal bonding portion 42b has a plate shape, and one main surface opposed to the second end surface 12f of the multilayer body 12 is connected to the second end surface 12f by the electrically conductive bonding agent 50. The shape of the second terminal bonding portion 42b is not particularly limited, but is preferably a rectangular or substantially rectangular shape.

The coupling portion 44 of the conductor portion 40 includes one end connected to one end of the first terminal bonding portion 42a and the other end connected to one end of the second terminal bonding portion 42b. The coupling portion 42 is provided at a predetermined interval t from the first main surface 12a of the multilayer body 12. The interval t, which is the shortest distance between the coupling portion 42 and the multilayer body 12, is preferably equal to or greater than the maximum thickness in the lamination direction x of the third external electrode 30c and the fourth external electrode 30d provided on the first main surface 12a. For example, the interval t is preferably about 10 μm or more. The shape of the coupling portion 44 is not particularly limited, but is preferably a rectangular or substantially rectangular shape.

The dimensions in the width direction y of the first terminal bonding portion 42a, the second terminal bonding portion 42b, and the coupling portion 44 defining the conductor portion 40 are preferably the same or substantially the same as the maximum dimension in the width direction y of the multilayer ceramic capacitor 10. Here, “substantially the same” indicates, for example, about 0.95 times or more and about 1.05 times or less with respect to the maximum dimension in the width direction y of the multilayer ceramic capacitor 10. This provides an advantageous effect in that the resistance value of the conductor portion 40, which originally has a low DC resistance value, becomes even lower, allowing a large current to flow.

Also, the respective thicknesses of the first terminal bonding portion 42a, the second terminal bonding portion 42b, and the coupling portion 44 that define the conductor portion 40 are preferably, for example, about 0.1 mm or less. This facilitates processing of the conductor portion 40, which is a plate-shaped lead frame, makes it easy to secure the shape, and has an advantageous effect of reducing the overall dimensions.

Each of the first terminal bonding portion 42a, the second terminal bonding portion 42b, and the coupling portion 44 that define the conductor portion 40 preferably includes a terminal body and a plating film provided on the surface of the terminal body.

The terminal body is preferably made of an alloy including, for example, Ni, Fe, Cu, Ag, Cr, or one or more of these metals as a main component. Specifically, for example, the base metal of the terminal body can be Fe-42Ni alloy, Fe-18Cr alloy, or Cu-8Sn alloy.

The plating film includes, for example, a lower plating film and an upper plating film. The lower plating film is provided on the surface of the terminal body, and the upper plating film is provided on the surface of the lower plating film. Each of the lower plating film and the upper plating film may include a plurality of plated layers.

The lower plating film is preferably made of an alloy including, for example, Ni, Fe, Cu, Ag, Cr, or one or more of these metals as a main component. More preferably, the lower plating film is made of an alloy including, for example, Ni, Fe, Cr, or one or more of these metals as a main component. The thickness of the lower plating film is preferably, for example, about 0.2 μm or more and about 5.0 μm or less.

The upper plating film is preferably made of an alloy including, for example, Sn, Ag, Au, or one or more of these metals as a main component. More preferably, for example, the upper plating film is made of Sn or an alloy including Sn as a main component. By forming the upper plating film with Sn or an alloy including Sn as a main component, it is possible to improve the solderability between the first terminal bonding portion 42a, the second terminal bonding portion 42b, and the coupling portion 44 and the external electrodes. The thickness of the upper plating film is preferably, for example, about 1.0 μm or more and about 5.0 μm or less.

Also, by forming each of the terminal body and the lower plating film with an alloy including, for example, high melting point Ni, Fe, Cr, or one or more of these metals as a main component, it is possible to improve the heat resistance of the external electrode.

As the electrically conductive bonding agent 50, for example, an epoxy-based adhesive for high heat resistance or solder can be used.

As described above, the electrically conductive bonding agent 50 is provided such that the first external electrode 30a of the multilayer ceramic capacitor 10 and the first terminal bonding portion 42a of the conductor portion 40 are electrically connected with each other. Also, the electrically conductive bonding agent 50 is provided such that the second external electrode 30b of the multilayer ceramic capacitor 10 and the second terminal bonding portion 42b of the conductor portion 40 are electrically connected with each other. This allows DC current to flow through the conductor portion 40, reduces the current flowing through the multilayer ceramic capacitor 10, and reduces or prevents temperature rise.

The DC resistance RdcA of the conductor portion 40 is smaller than the DC resistance RdcB of the multilayer ceramic capacitor 10. That is, RdcA<RdcB is satisfied.

Since the DC resistance RdcA of the conductor portion 40 is smaller than the DC resistance RdcB of the multilayer ceramic capacitor 10, the DC current more preferentially flows into the conductor portion 40, and the electric current flowing through the multilayer ceramic capacitor 10 is reduced, such that it is possible to reduce or prevent a temperature rise as an advantageous effect. In particular, since the conductor portion 40 is configured as a plate-shaped lead frame, the DC resistance RdcA of the conductor portion 40 is lower than the DC resistance RdcB of the multilayer ceramic capacitor 10, such that it is possible to allow the DC current to flow to the conductor portion 40 configured as the plate-shaped lead frame, and it is possible to further reduce or prevent heat generation of the multilayer ceramic capacitor 10 as an advantageous effect.

On the other hand, when the DC resistance RdcA of the conductor portion 40 is larger than the DC resistance RdcB of the multilayer ceramic capacitor 10, an electric current flows through the multilayer ceramic capacitor 10 more than the conductor portion 40, and thus it is difficult to obtain the advantageous effect of handling a large electric current.

The conductor portion 40 is not electrically connected to the third external electrode 30c and the fourth external electrode 30d. By providing the conductor portion 40 so as to be electrically connected only to the first external electrode 30a and the second external electrode 30b of the multilayer ceramic capacitor 10, the DC current flows through the conductor portion 40, and an electric current flowing through the multilayer ceramic capacitor 10 is reduced, such that it is possible to reduce or prevent a temperature rise.

The DC resistance values of the conductor portion 40 and the multilayer ceramic capacitor 10 are measured after removing the electrically conductive bonding agent 50 bonded thereto and removing them, and the respective DC resistance values are compared. The DC resistance values of the conductor portion 40 and the multilayer ceramic capacitor 10 are measured in accordance with JIS C2139 using a four-terminal method in which about 100 mA is supplied. The locations where the terminals are applied are not limited, and the respective Rdc may be measured at two points including the tip of the conductor portion 40 and the middle portion of the multilayer ceramic capacitor 10 in the lamination direction x.

According to the multilayer ceramic electronic component 100 shown in FIG. 1, the DC resistance RdcA of the conductor portion 40 connected to the multilayer ceramic capacitor 10 is smaller than the DC resistance RdcB of the multilayer ceramic capacitor 10. This allows the DC current to flow through the conductor portion and allows the AC current to escape to the multilayer ceramic capacitor 10. More specifically, since the DC current is likely to flow to the side having a lower DC resistance, the DC current is likely to flow to the conductor portion 40 having a lower DC resistance than the multilayer ceramic capacitor 10. On the other hand, since the AC current is likely to flow toward the side having a low impedance, the AC current is likely to flow toward the multilayer ceramic capacitor 10 having the low impedance. With such a configuration, it is possible to increase the capacitance of the multilayer ceramic capacitor 10 and reduce or prevent an increase in DC resistance. Further, it is possible to handle a large electric current by simply attaching the conductor portion 40 to the existing multilayer ceramic capacitor 10, without newly designing an internal configuration unique for each capacitance of the multilayer ceramic capacitor 10. This also increases the developability of the product lineup.

Next, a mounting structure 500 of the multilayer ceramic electronic component 100 according to the present example embodiment will be described.

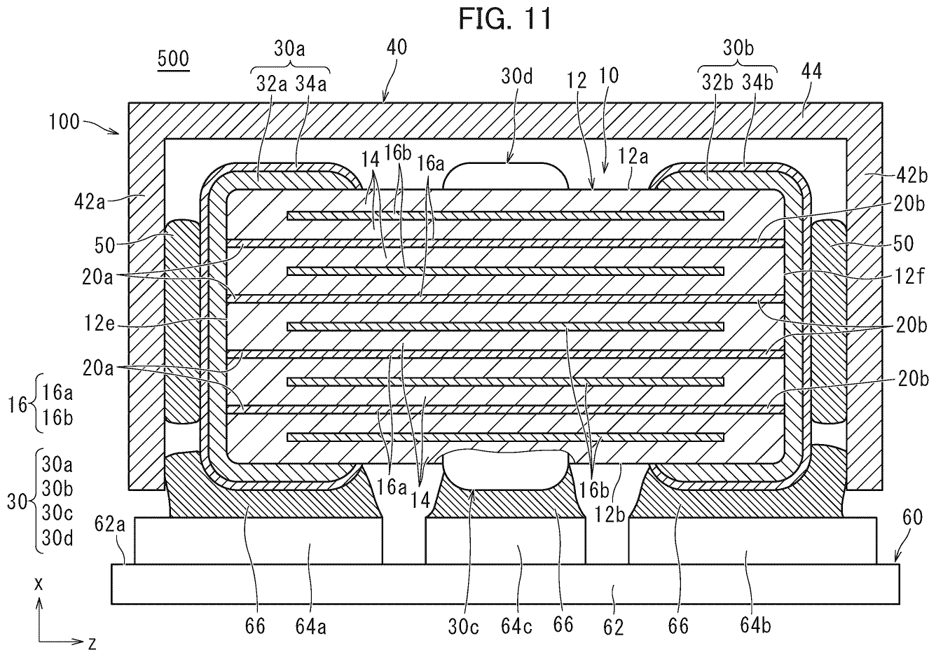

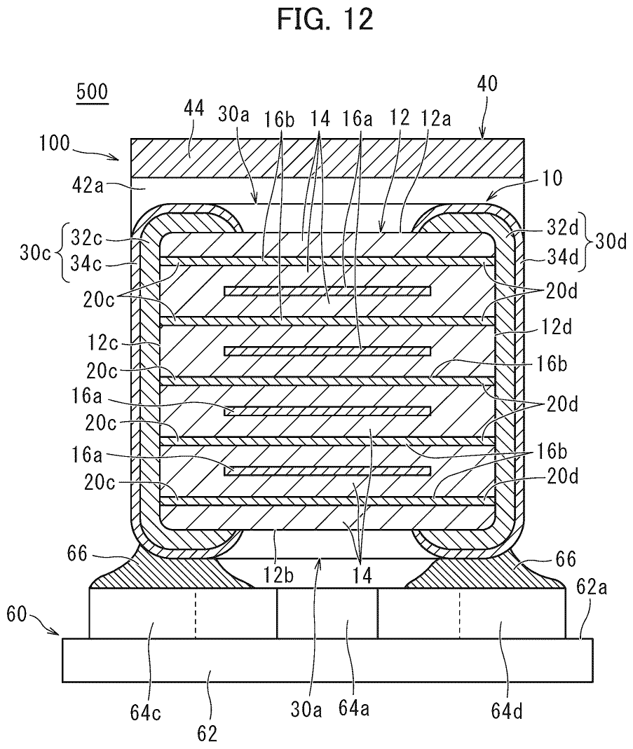

FIG. 11 is a cross-sectional view in the lamination direction showing a mounting structure of the multilayer ceramic electronic component according to an example embodiment of the present invention. FIG. 12 is a cross-sectional view in the width direction showing the mounting structure of the multilayer ceramic electronic component according to the present example embodiment of the present invention.

As shown in FIGS. 11 and 12, the mounting structure 500 of the multilayer ceramic electronic component according to the present example embodiment includes the multilayer ceramic electronic component 100 according to the present example embodiment and a mounting substrate 60. The mounting substrate 60 includes the core material 62 of the substrate and the connection conductor (conductor land) 64.

The core material 62 of the substrate includes, for example, a substrate made of a material obtained by impregnating a base material obtained by mixing a glass cloth and a glass nonwoven fabric with an epoxy resin or a polyimide resin, or a ceramic substrate manufactured by firing a sheet obtained by mixing ceramics and glass. The core material 62 of the substrate may be a single-layer substrate or a substrate including a plurality of laminated layers. The thickness of the core material 62 of the substrate is not particularly limited, but is preferably about 200 μm or more and about 800 μm or less, for example.

One main surface of the core material 62 of the substrate is provided with the conductor land 64 and defines a substrate-side mounting surface 62a defining and functioning as a mounting surface of the multilayer ceramic electronic component 100.

The conductor land 64 includes a first conductor land 64a, a second conductor land 64b, a third conductor land 64c, and a fourth conductor land 64d.

The first conductor land 64a is electrically connected to the first external electrode 30a of the multilayer ceramic capacitor 10 by a bonding material 66, and is also mechanically bonded thereto. The second conductor land 64b is electrically connected to the second external electrode 30b of the multilayer ceramic capacitor 10 by the bonding material 66, and is also mechanically bonded thereto. The third conductor land 64c is electrically connected to the third external electrode 30c of the multilayer ceramic capacitor 10 by the bonding material 66, and is also mechanically bonded thereto. The fourth conductor land 64d is electrically connected to the fourth external electrode 30d of the multilayer ceramic capacitor 10 by the bonding material 66, and is also mechanically bonded thereto.

The conductor land 64 may be provided on the main surface of the core material 62 of the substrate opposite to the substrate-side mounting surface 62a.

Although the material of the conductor land 64 is not particularly limited, for example, a metal such as Cu, Au, Pd, or Pt can be used. The thickness of each of the conductor lands 64, that is, the dimension in the lamination direction x, is not particularly limited, but is preferably, for example, about 20 μm or more and about 200 μm or less. As the bonding material 66, for example, an epoxy-based adhesive for high heat resistance, or solder can be used.

In the above description, the mounting substrate 60 corresponds to the mounting substrate. The core material 62 of the substrate corresponds to the core material of the substrate. The substrate-side mounting surface 62a corresponds to the mounting surface. The plurality of conductor lands 64 corresponds to a plurality of connection conductors. However, the connection conductor is not limited to a land and is not limited by other applications, functions, shapes, names, etc., as long as the connection conductor is a conductor that is provided between the multilayer ceramic capacitor 10 and the mounting substrate 60, and can electrically connect them to each other.

The mounting structure 500 of the multilayer ceramic electronic component shown in FIGS. 11 and 12 is preferably configured such that the multilayer ceramic electronic component 100 is mounted so that the conductor portion 40 of the multilayer ceramic electronic component 100 is provided on the side opposite to the mounting substrate 60. That is, the conductor portion 40 of the multilayer ceramic electronic component 100 is provided adjacent to the first main surface (non-mounting surface side) of the multilayer ceramic capacitor 10, and the multilayer ceramic capacitor 10 of the multilayer ceramic electronic component 100 is preferably mounted on the side adjacent to the mounting substrate 60. By mounting in this manner, the distance between the multilayer ceramic capacitor 10 and the mounting substrate 60 is not increased, such that the low ESL effect is easily obtained. In addition, it is possible to mount without affecting the mounting of the multilayer ceramic electronic component 100 to the mounting substrate.

Next, an example of a manufacturing method of the multilayer ceramic capacitor 10 of the multilayer ceramic electronic component 100 according to the present example embodiment of the present invention will be described.

First, a dielectric sheet for manufacturing the dielectric layers and an electrically conductive paste for manufacturing the internal electrode layers are prepared. The dielectric sheet and the electrically conductive paste for manufacturing the internal electrode layers include a binder and a solvent. Known binders and solvents can be used.

Next, the electrically conductive paste for manufacturing the internal electrode layers is printed on the dielectric sheet in predetermined patterns by, for example, screen printing or gravure printing. The dielectric sheet on which the patterns of the first internal electrode layers 16a and the second internal electrode layers 16b are formed is thus prepared. More specifically, for example, a screen plate for printing the first internal electrode layers 16a and a screen plate for printing the second internal electrode layers 16b are separately prepared, and the internal electrode layers 16 of the present example embodiment can be printed using a printing machine capable of separately printing two types of screen plates. Here, in order to obtain a desired configuration, the sheet on which the first internal electrode layer 16a is printed and the sheet on which the second internal electrode layer 16b is printed are laminated to form a portion defining and functioning as the inner layer portion 15a. In the present example embodiment, the internal electrode layer 16 is printed by screen printing, for example.

Next, by laminating a predetermined number of dielectric sheets on which the pattern of the internal electrode layer is not printed, a portion defining and functioning as the first outer layer portion 15b1 adjacent to the first main surface 12a is formed. Thereafter, the portion defining and functioning as the inner layer portion 15a prepared above is laminated, and a predetermined number of dielectric sheets on which the pattern of the internal electrode layer is not printed are laminated on the portion functioning as the inner layer portion 15a, such that a portion defining and functioning as the second outer layer portion 15b2 adjacent to the second main surface 12b is formed. A multilayer sheet is manufactured with such a method.

Next, the multilayer sheet is pressed in the lamination direction by, for example, isostatic pressing or the like to produce a multilayer block.

Subsequently, the multilayer block is cut to a predetermined size to cut out multilayer chips. At this time, corner portions and ridge portions of the multilayer chips may be rounded by, for example, barrel polishing or the like.

Next, each of the multilayer chips is fired to produce the multilayer body 12. The firing temperature depends on the materials of the dielectric layer 14 and the internal electrode layer 16, but is preferably, for example, about 900° C. or more and about 1400° C. or less.

The third base electrode layer 32c of the third external electrode 30c and the fourth base electrode layer 32d of the fourth external electrode 30d are respectively formed on the first lateral surface 12c and the second lateral surface 12d of the multilayer body 12 obtained by firing.

In a case in which a fired layer is formed as the base electrode layer 32, an electrically conductive paste including a glass component and a metal component is applied, and then fired to form the base electrode layer 32. The temperature of the firing treatment at this time is preferably, for example, about 700° C. or more and about 900° C. or less. In the present example embodiment, the base electrode layer 32 is formed with a fired layer.

Here, as the method of forming the fired layer as the third base electrode layer 32c and the fourth base electrode layer 32d, various methods can be used. For example, the third base electrode layer 32c and the fourth base electrode layer 32d can be formed by a method in which an electrically conductive paste is applied by being extruded through slits. In the case of this method, by increasing the extrusion amount of the electrically conductive paste, the third base electrode layer 32c and the fourth base electrode layer 32d can be formed not only on the first lateral surface 12c and the second lateral surface 12d, but also on a portion of the first main surface 12a and a portion of the second main surface 12b.

Alternatively, for example, a roller transfer method can be used. In the case of the roller transfer method, in a case in which the third base electrode layer 32c and the fourth base electrode layer 32d are formed not only on the first lateral surface 12c and the second lateral surface 12d, but also on a portion of the first main surface 12a and a portion of the second main surface 12b, the third base electrode layer 32c and the fourth base electrode layer 32d can be formed on a portion of the first main surface 12a and a portion of the second main surface 12b by increasing the pressing pressure during roller transfer.

Next, the first base electrode layer 32a of the first external electrode 30a and the second base electrode layer 32b of the second external electrode 30b are formed on the first end surface 12e and the second end surface 12f of the multilayer body 12 obtained by firing. Similarly to the third base electrode layer 32c and the fourth base electrode layer 32d, in a case of forming a fired layer defining and functioning as the first base electrode layer 32a and the second base electrode layer 32b, an electrically conductive paste including a glass component and a metal component is applied, and then fired to form the first base electrode layer 32a and the second base electrode layer 32b. The temperature of the firing treatment at this time is preferably, for example, about 700° C. or more and about 900° C. or less.

Regarding the firing processing, the first base electrode layer 32a of the first external electrode 30a, the second base electrode layer 32b of the second external electrode 30b, the third base electrode layer 32c of the third external electrode 30c, and the fourth base electrode layer 32d of the fourth external electrode 30d may be simultaneously fired, or the third base electrode layer 32c of the third external electrode 30c and the fourth base electrode layer 32d of the fourth external electrode 30d on the lateral surface may be fired, and the first base electrode layer 32a of the first external electrode 30a and the second base electrode layer 32b of the second external electrode 30b on the end surface may be fired.

In a case in which the base electrode layer 32 is formed with an electrically conductive resin layer, the electrically conductive resin layer can be formed by the following method, for example. Further, the electrically conductive resin layer may be formed on the surface of the fired layer, or the electrically conductive resin layer may be formed directly on the multilayer body 12 as a single body without forming the fired layer.

As an example of a method of forming the electrically conductive resin layer, an electrically conductive resin paste including a thermosetting resin and a metal component is applied onto the fired layer or the multilayer body 12, and heat treatment is performed at a temperature of, for example, about 250° C. or more and about 550° C. or less to thermally cure the resin, thus forming the electrically conductive resin layer. At this time, the atmosphere during the heat treatment is preferably, for example, an N2 atmosphere. Further, in order to prevent scattering of the resin and oxidation of various metal components, the oxygen concentration is preferably, for example, about 100 ppm or less.

As a method of applying the electrically conductive resin paste, for example, a method of applying the electrically conductive resin paste by extruding the electrically conductive resin paste through a slit or a roller transfer method can be used in the same manner as the method of forming the base electrode layer 32 with the fired layer.

In a case in which the base electrode layer 32 is formed with a thin film layer, masking or the like is performed, and the base electrode layer 32 can be formed by a thin film formation method such as, for example, a sputtering method or a vapor deposition method at a portion where the base electrode layer 32 is desired to be formed. The base electrode layer 32 formed with a thin film layer is a layer having a thickness of, for example, about 1 μm or less on which metal particles are deposited.

Finally, the plated layer 34 is formed. The plated layer 34 may be formed on the surface of the base electrode layer 32, or may be formed directly on the multilayer body 12. In the present example embodiment, the plated layer 34 is formed on the surface of the base electrode layer 32. More specifically, for example, a Ni plated layer and a Sn plated layer are formed on the base electrode layer 32. In a case in which plating is performed, either electrolytic plating or electroless plating may be used. However, electroless plating requires pretreatment with a catalyst or the like in order to improve the plating deposition rate, and has a disadvantage in that the processing becomes complicated. Therefore, in general, electrolytic plating is preferably used.

The multilayer ceramic capacitor 10 shown in FIG. 1 can be manufactured in the above way.

Subsequently, the conductor portion 40 is attached to the multilayer ceramic capacitor 10. First, the conductor portion 40 is prepared. The conductor portion 40 is configured as a plate-shaped lead frame.

Next, the terminal bonding portions 42a and 42b of the conductor portion 40 are aligned upward in a first transfer jig, and held by suction.

Subsequently, at a position where the multilayer ceramic capacitor 10 is mounted on a second transfer jig, an electrically conductive bonding agent 50, for example, terminal bonding solder, is applied in advance by, for example, screen printing or the like. Next, the multilayer ceramic capacitor 10 is aligned on the second transfer jig. Then, the first transfer jig is inverted while the plurality of prepared conductor portions 40 are held by suction.

Next, the conductor portion 40 held by the first transfer jig is placed over the multilayer ceramic capacitor 10 aligned on the second transfer jig. Then, reflow processing is performed with the conductor portion 40 held by the first transfer jig placed over the multilayer ceramic capacitor 10 aligned on the second transfer jig. During the attachment of the conductor portion 40, the reflow temperature for soldering with the electrically conductive bonding agent 50 is preferably, for example, about 270° C. or more and about 290° C. or less, and this heat is preferably applied for about 30 seconds or more. During the reflow processing, the electrically conductive bonding agent 50 is drawn up and filled between the first external electrode 30a and the first terminal bonding portion 42a of the conductor portion 40 and between the second external electrode and the second terminal bonding portion 42b of the conductor portion 40 by capillary action. As a result, the first external electrode 30a and the first terminal bonding portion 42a, and the second external electrode 30b and the second terminal bonding portion 42b are respectively connected via the electrically conductive bonding agent 50.

The multilayer ceramic capacitor 10 and the conductor portion 40 may be joined by welding.

Then, the multilayer ceramic electronic component 100 is removed from the second transfer jig, and a desired multilayer ceramic electronic component 100 is obtained.

The multilayer ceramic electronic component 100 shown in FIG. 1 is manufactured in the above way.

Hereinafter, each modified example (first modified example and second modified example) of the multilayer ceramic capacitor in the multilayer ceramic electronic component according to the first example embodiment will be described. For these modified examples, components corresponding to those of the above example embodiment are denoted by the same reference numerals, and detailed descriptions thereof are omitted.

The multilayer ceramic capacitor 10A according to a first modified example of the present example embodiment is different from the multilayer ceramic capacitor 10 according to the present example embodiment only in the configuration of the multilayer body 12A of the multilayer ceramic capacitor 10A. Therefore, the same or corresponding components as those of the multilayer ceramic capacitor 10 are denoted by the same reference numerals, and descriptions thereof are omitted.

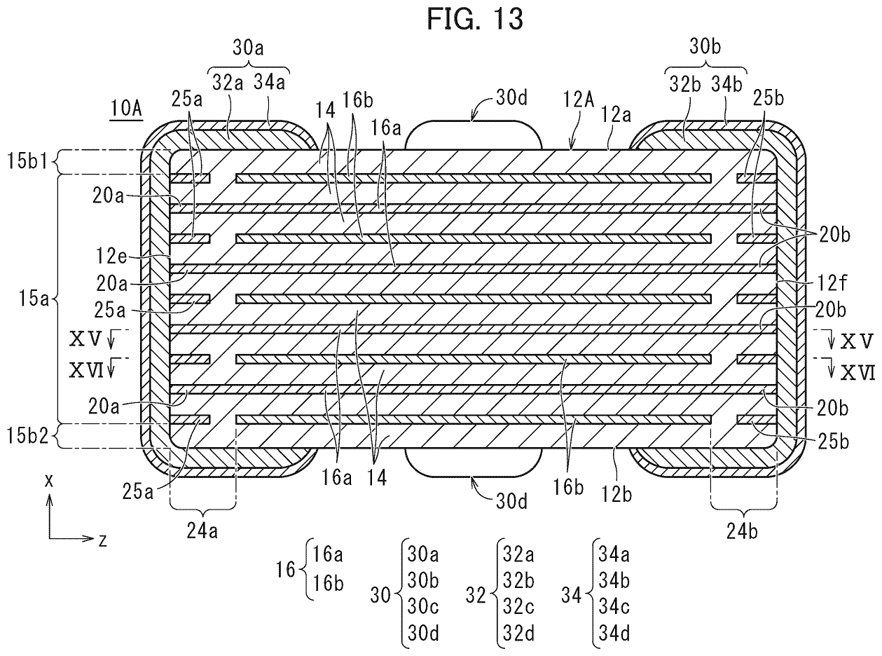

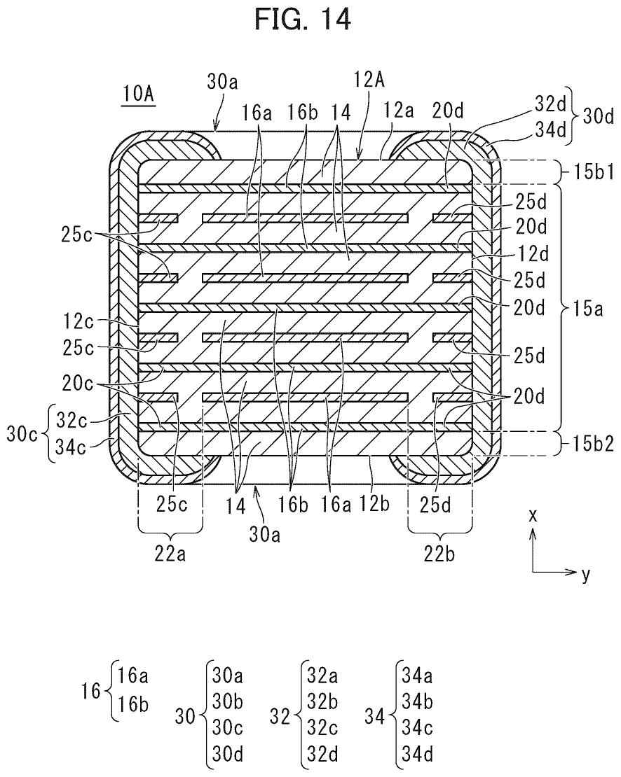

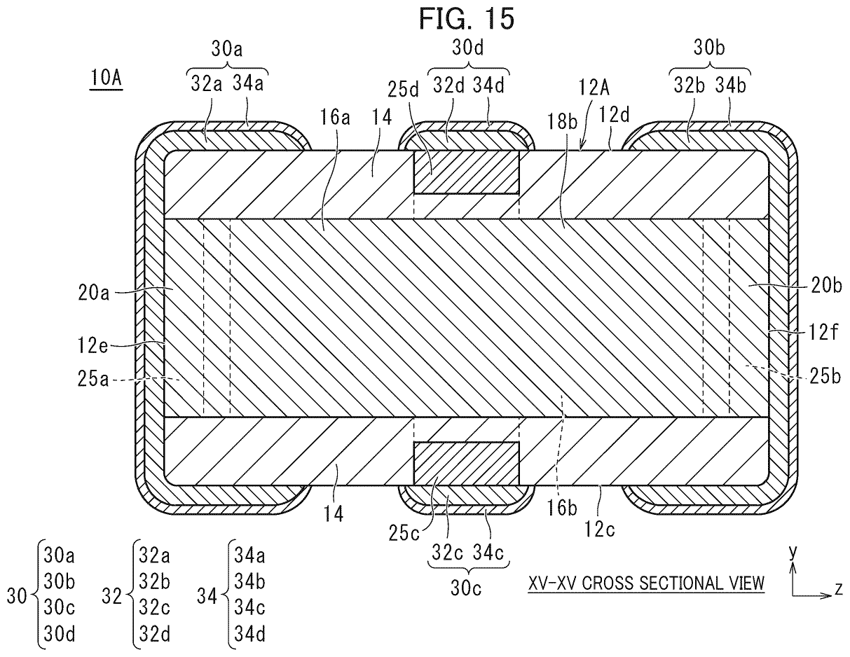

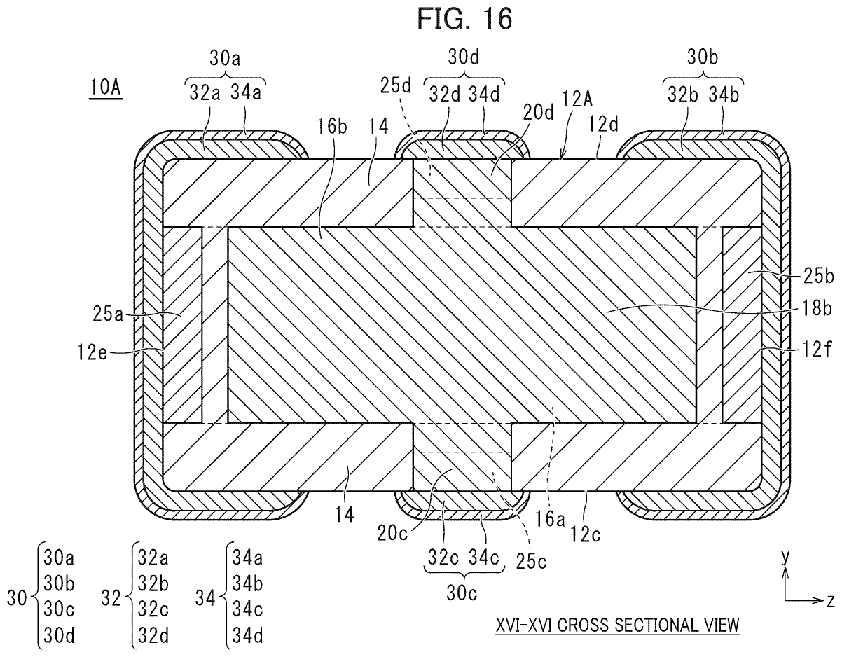

FIG. 13 is a cross-sectional view showing a first modified example of the multilayer ceramic capacitor according to the first example embodiment of the present invention, and is a view corresponding to the cross-sectional view of FIG. 7. FIG. 14 is a cross-sectional view showing the first modified example of the multilayer ceramic capacitor according to the first example embodiment of the present invention, and is a view corresponding to the cross-sectional view of FIG. 8. FIG. 15 is a cross-sectional view taken along the line XV-XV of FIG. 13. FIG. 16 is a cross-sectional view taken along the line XVI-XVI of FIG. 13.

The multilayer ceramic capacitor 10A includes a multilayer body 12A and external electrodes 30.

The multilayer body 12A includes a plurality of laminated dielectric layers 14. Further, the multilayer body 12A includes a first main surface 12a and a second main surface 12b opposed to each other in the lamination direction x, a first lateral surface 12c and a second lateral surface 12d opposed to each other in the width direction y orthogonal or substantially orthogonal to the lamination direction x, and a first end surface 12e and a second end surface 12f opposed to each other in the length direction z orthogonal or substantially orthogonal to the lamination direction x and the width direction y.

In the end portions (L gaps) 24a and 24b of the multilayer body 12A, first dummy electrodes 25a are provided to be exposed at the first end surface 12e, and second dummy electrodes 25b are provided to be exposed at the second end surface 12f.

Each of the first dummy electrodes 25a and each of the second dummy electrodes 25b are preferably provided on the same plane as corresponding ones of the second internal electrode layers 16b, and have the same or substantially the same thickness as corresponding ones of the second internal electrode layers 16b.

In a case in which the coverages of the first dummy electrodes 25a and the second dummy electrodes 25b are reduced, the electric current path can be shortened.

The first dummy electrodes 25a and the second dummy electrodes 25b may also be provided in the first outer layer portion 15b1 and the second outer layer portion 15b2. In this case, it is preferable that the end portions (L gaps) 24a and 24b of the multilayer body 212 are provided on a portion corresponding to a position to which the end portions (L gaps) 24a and 24b are moved in parallel or substantially in parallel in the lamination direction x. With this configuration, in a case in which the plated layer 34 is provided without providing the base electrode layer 32, the plated layer 34 is easily formed.

Further, in a case in which each of the first dummy electrodes 25a and each of the second dummy electrodes 25b are provided on the same plane as corresponding ones of the second internal electrode layers 16b, each of the first dummy electrodes 25a and each of the second dummy electrodes 25b can be provided on the same plane as corresponding ones of the second internal electrode layers 16b by printing the first dummy electrodes 25a and the second dummy electrodes 25b together with the second internal electrode layers 16b when the second internal electrode layers 16b are printed.

In addition, in the side portion (W gap) 22a of the multilayer body 12A, the third dummy electrodes 25c may be exposed at the first lateral surface 12c, and in the side portion (W gap) 22b of the multilayer body 12A, the fourth dummy electrodes 25d may be exposed at the second lateral surface 12d.

Each of the third dummy electrodes 25c and each of the fourth dummy electrodes 25d are preferably provided on the same plane as corresponding ones of the first internal electrode layers 16a, and have the same or substantially the same thickness as the first internal electrode layers 16a.

In a case in which the coverages of the third dummy electrodes 25c and the fourth dummy electrodes 25d are reduced, the electric current path can be shortened.

The third dummy electrodes 25c and the fourth dummy electrodes 25d may also be provided in the first outer layer portion 15b1 and the second outer layer portion 15b2. In this case, it is preferred that the side portions (W gaps) 22a and 22b of the multilayer body 12A are provided on a portion corresponding to a position to which the side portions (W gaps) 22a and 22b are moved in parallel or substantially parallel in the lamination direction x. With this configuration, in a case in which the plated layer 34 is provided without providing the base electrode layer 32, the plated layer 34 is easily formed.

Further, in a case in which each of the third dummy electrodes 25c and each of the fourth dummy electrodes 25d are provided on the same plane as corresponding ones of the first internal electrode layers 16a, the third dummy electrode 25c and the fourth dummy electrode 25d can be provided on the same plane as corresponding ones of the first internal electrode layers 16a by printing the third dummy electrode 25c and the fourth dummy electrode 25d together with the second internal electrode layer 16b when the first internal electrode layer 16a is printed.

In the multilayer ceramic capacitor 10A shown in FIGS. 13 to 16, since the first dummy electrodes 25a, the second dummy electrodes 25b, the third dummy electrodes 25c, and the fourth dummy electrodes 25d are provided in the side portions (W gaps) 22a and 22b and the end portions (L gaps) 24a and 24b of the multilayer body 12A, it is possible to reduce or prevent distortion during pressing.

The multilayer ceramic capacitor 10B according to a second modified example of the present example embodiment is different from the multilayer ceramic capacitor 10 according to the present example embodiment only in the structure of the multilayer body 12B of the multilayer ceramic capacitor 10B. Therefore, the same or corresponding components as those of the multilayer ceramic capacitor 10 are denoted by the same reference numerals, and descriptions thereof are omitted.

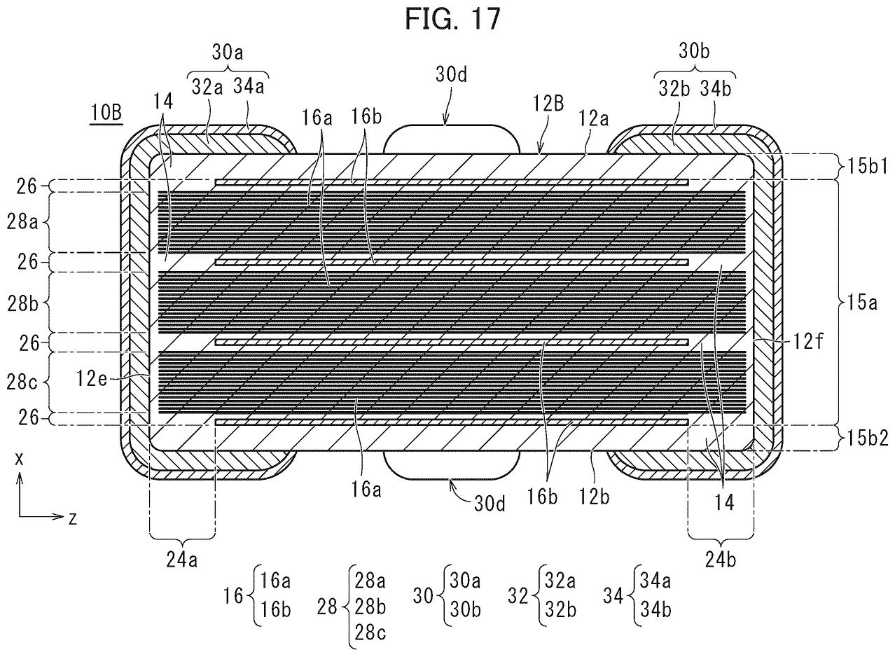

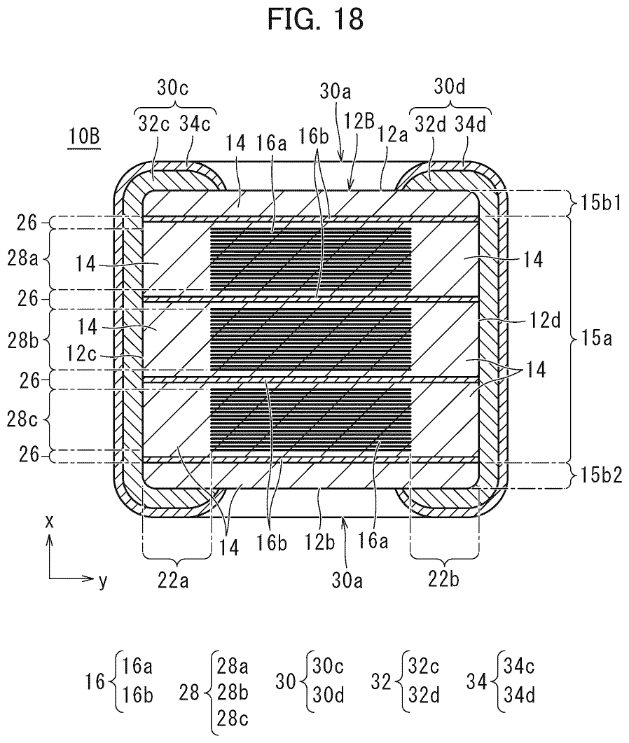

FIG. 17 is a cross-sectional view showing a second modified example of the multilayer ceramic capacitor according to the first example embodiment of the present invention, and is a view corresponding to the cross-sectional view of FIG. 7. FIG. 18 is a cross-sectional view showing a second modified example of the multilayer ceramic capacitor according to the first example embodiment of the present invention, and is a view corresponding to the cross-sectional view of FIG. 8.

The multilayer body 12B includes a plurality of laminated dielectric layers 14. Further, the multilayer body 12B includes a first main surface 12a and a second main surface 12b opposed to each other in the lamination direction x, a first lateral surface 12c and a second lateral surface 12d opposed to each other in the width direction y orthogonal or substantially orthogonal to the lamination direction x, and a first end surface 12e and a second end surface 12f opposed to each other in the length direction z orthogonal or substantially orthogonal to the lamination direction x and the width direction y.

The multilayer body 12B includes an inner layer portion 15a, and a first outer layer portion 15b1 and a second outer layer portion 15b2 that sandwich the inner layer portion 15a in the lamination direction x.

The dielectric layers 14 in the inner layer portion 15a may be sandwiched between the first internal electrode layers 16a. In this case, the first internal electrode layers 16a are continuously provided with a corresponding one of the dielectric layers 14 in the inner layer portion 15a interposed therebetween.

In addition, each of the dielectric layers 14 in the inner layer portion 15a may be sandwiched between the second internal electrode layers 16b. In this case, the second internal electrode layers 16b are continuously provided with a corresponding one of the dielectric layers 14 in the inner layer portion 15a interposed therebetween. The dielectric layers 14 in the inner layer portion 15a is made of, for example, dielectric ceramic particles including a perovskite compound including Ba and Ti as a main component and having a perovskite structure. In addition, for example, at least one of Si, Mg, Ba, or Mn may be added as an additive to these main components. The additive is present between the ceramic particles.

The inner layer portion 15a of the multilayer body 12B includes capacitance generating portions 26 in which the first internal electrode layers 16a and the second internal electrode layers 16b are opposed to each other with a corresponding one of the dielectric layers 14 interposed therebetween to generate capacitance, and internal electrode laminated portions 28 which are regions in each of which two or more first internal electrode layers 16a are continuously laminated. In the multilayer ceramic capacitor 10B, the capacitor characteristics are provided by the capacitance generating portions 26.

Further, the internal electrode laminated portions 28 are divided into a plurality of internal electrode laminated portions 28 by the second internal electrode layers 16b. With such a configuration, since the assemblies of the first internal electrode layers 16a are separated, the heat dissipation effect is improved, and it is possible to achieve the advantageous effect of reducing or preventing a temperature rise.

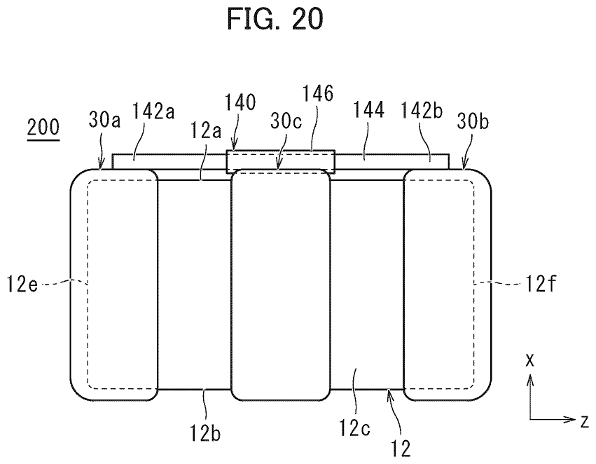

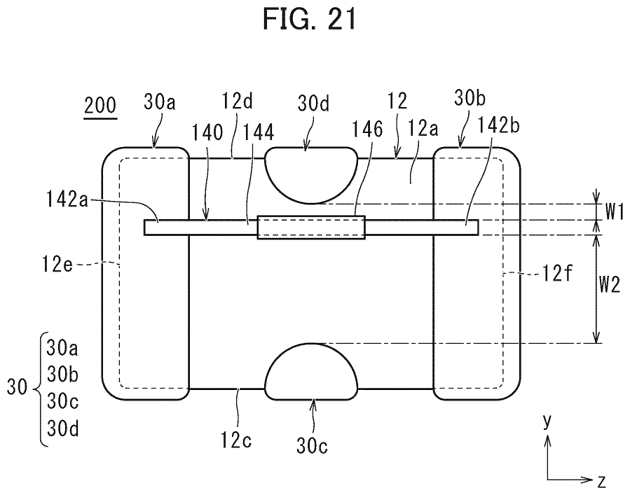

As shown in FIGS. 20 and 21, in the multilayer ceramic capacitor 10B, the internal electrode laminated portions 28 are divided by two second internal electrode layers 16b. Specifically, the internal electrode laminated portions 28 are divided into a first internal electrode laminated portion 28a, a second internal electrode laminated portion 28b, and a third internal electrode laminated portion 28c.

The second internal electrode layers 16b provided to divide the internal electrode laminated portions 28, which are regions in each of which two or more first internal electrode layers 16a are continuously laminated, may be provided singularly. With such a configuration, it is possible to laminate more first internal electrode layers 16a, and it is possible to achieve an advantageous effect of reducing DC resistance.

In addition, the second internal electrode layers 16b provided to divide the internal electrode laminated portions 28, which are regions in each of which two or more first internal electrode layers 16a are continuously laminated, may be provided as two or more layers that are continuously laminated. With such a configuration, even when the number of the second internal electrode layers 16b is reduced, the connectivity between the second internal electrode layer 16b and the external electrode 30 can be made more sufficient.

The second internal electrode layers 16b may be provided between the internal electrode laminated portion 28, which is a region in which two or more first internal electrode layers 16a located adjacent to the first main surface 12a of the multilayer body 12B are continuously laminated, that is, the first internal electrode laminated portion 28a, and the first main surface 12a, and may be provided between the internal electrode laminated portion 28, which is a region in which two or more first internal electrode layers 16a located adjacent to the second main surface 12b of the multilayer body 12B are continuously laminated, that is, the third internal electrode laminated portion 28c, and the second main surface 12b. With such a configuration, since the capacitance generating portions 26 can be provided also in the vicinity of the first outer layer portion 15b1 and the second outer layer portion 15b2, a portion of the capacitance can be generated, the electric current path to the mounting substrate can be shortened, and thus, it is possible to achieve the advantageous effect of low ESL.

The second internal electrode layers 16b may not necessarily be provided between the internal electrode laminated portion 28, which is a region in which two or more first internal electrode layers 16a located adjacent to the first main surface 12a of the multilayer body 12B are continuously laminated, that is, the first internal electrode laminated portion 28a, and the first main surface 12a, and may not necessarily be provided between the internal electrode laminated portion 28, which is a region in which two or more first internal electrode layers 16a located adjacent to the second main surface 12b of the multilayer body 12B are continuously laminated, that is, the third internal electrode laminated portion 28c, and the second main surface 12b. With such a configuration, the distance from the surface of the multilayer body 12B to the capacitance generating portion 26 where capacitance is generated becomes large, and even if cracks occur from the surface of the multilayer body 12B due to external load, it is possible to achieve the advantageous effect in that insulation resistance deterioration is less likely to occur.

The thickness of each of the dielectric layers 14 adjacent to the second internal electrode layer 16b is preferably larger than the thickness of each of the dielectric layers 14 sandwiched between the first internal electrode layers 16a. With such a configuration, it is possible to laminate more first internal electrode layers 16a, and it is possible to further increase the advantageous effect of reducing DC resistance.

Further, the thickness of the second internal electrode layer 16b is preferably larger than the thickness of the first internal electrode layer 16a. With such a configuration, even if the capacitance is further reduced, the connectivity between the third extension electrode portion 20c of each of the second internal electrode layers 16b and the third external electrode 30c provided on the first lateral surface 12c can be ensured, and the connectivity between the fourth extension electrode portion 20d of each of the second internal electrode layers 16b and the fourth external electrode 30d provided on the second lateral surface 12d can be ensured.

Next, a multilayer ceramic electronic component 200 according to a second example embodiment of the present invention will be described.

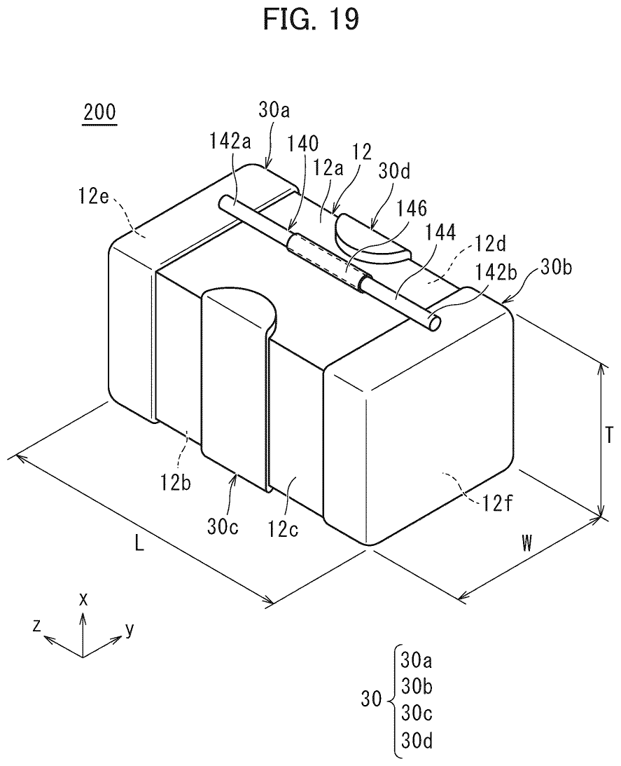

FIG. 19 is an external perspective view showing a multilayer ceramic electronic component according to a second example embodiment of the present invention. FIG. 20 is a front view of the multilayer ceramic electronic component according to the second example embodiment of the present invention. FIG. 21 is a plan view of the multilayer ceramic electronic component according to the second example embodiment of the present invention. In FIGS. 19 to 21, the same or corresponding portions as those of the multilayer ceramic electronic component 100 shown in FIG. 1 are denoted by the same reference numerals, and descriptions thereof are omitted.

The conductor portion 140 shown in FIGS. 19 to 21 is different from the conductor portion 40 and includes a metal terminal. At this time, the metal terminal is preferably a metal having a circular or substantially circular cross section perpendicular or substantially perpendicular to the length direction z. For example, when a metal terminal having a rolled metal plate shape is used, processing becomes easier than the metal plate itself, and there is an advantageous effect in that connection with the multilayer ceramic capacitor 10 becomes easier.

Further, when the conductor portion 140 includes a conductor such as a lead wire, for example, the lead wire itself can be used, such that additional processing is not necessary, and there is an advantageous effect in that material cost can be reduced.

The conductor portion 140 includes a first terminal bonding portion 142a including one end connected to the first external electrode 30a provided on the first main surface 12a, a second terminal bonding portion 142b including the other end connected to the second external electrode 30b provided on the first main surface 12a, and a coupling portion 144 connecting the first terminal bonding portion 142a and the second terminal bonding portion 142b.

The first terminal bonding portion 142a of the conductor portion 140 is a portion connected to the first external electrode 30a provided on the first main surface 12a of the multilayer body 12. The first terminal bonding portion 142a is connected by the electrically conductive bonding agent 50 on the first main surface 12a.

The second terminal bonding portion 142b of the conductor portion 140 is a portion connected to the second external electrode 30b provided on the second main surface 12b of the multilayer body 12. The second terminal bonding portion 142b is connected by the electrically conductive bonding agent 50 on the first main surface 12a.

The coupling portion 144 of the conductor portion 140 is not electrically connected to the third external electrode 30c or the fourth external electrode 30d. More specifically, it is preferable that a distance w1 in the width direction y between the conductor portion 140 and the third external electrode 30c is, for example, about 10 μm or more. Similarly, it is preferable that a distance w2 in the width direction y between the conductor portion 140 and the fourth external electrode 30d is, for example, about 10 μm or more. This makes it difficult to electrically connect to the first lateral surface external electrode 30c and the second lateral surface external electrode 30d, even when an impact is applied to the multilayer ceramic electronic component 200.

The coupling portion 144 of the conductor portion 140 may be subjected to insulation processing near the third external electrode 30c and the fourth external electrode 30d. Specifically, it is preferable that an insulating portion 146 covered with insulating resin is provided in the coupling portion 144 of the conductor portion 140 at portions adjacent to the third external electrode 30c and the fourth external electrode 30d.

When a lead wire is used as the material of the conductor portion 140, it is preferable to use, for example, a copper wire such as tough pitch copper or a copper-coated steel wire for the core wire of the lead wire. It is preferable to apply plating of, for example, Sn-based alloy to the surface layer of the lead wire. It is preferred that the diameter of the lead wire is, for example, about 0.5 mm or more and about 0.8 mm or less.

RdcA, which is the DC resistance of the conductor portion 40, is smaller than RdcB, which is the DC resistance of the multilayer ceramic capacitor 10. That is, RdcA<RdcB is satisfied.

The electrically conductive bonding agent 50 for connecting the conductor portion 140 and the external electrode 30 is the same as the electrically conductive bonding agent 50 used in the first example embodiment.

The DC resistance values of the conductor portion 140 and the multilayer ceramic capacitor 10 are measured after removing the electrically conductive bonding agent 50 bonded thereto and removing them, and the DC resistance values are compared. The DC resistance values of the conductor portion 140 and the multilayer ceramic capacitor 10 are measured in accordance with JIS C2139using the four-terminal method in which about 100 mA is supplied. The locations where the terminals are applied are not limited, and the respective Rdc may be measured at two points including the tip of the conductor portion 140 and the middle portion of the multilayer ceramic capacitor 10 in the lamination direction x.

The multilayer ceramic capacitor 10 in the multilayer ceramic electronic component 200 according to the second example embodiment may be the multilayer ceramic capacitors 10A and 10B shown in the modified examples of the multilayer ceramic electronic component 100 according to the first example embodiment.

The multilayer ceramic electronic component 200 shown in FIG. 19 provides the same or substantially the same advantageous effects as the multilayer ceramic electronic component 100, as well as providing the following advantageous effects. That is, when a metal terminal having a rolled metal plate shape is used for the conductor portion 140, processing becomes easier than the metal plate itself, and connection to the multilayer ceramic capacitor 10 becomes easier. In addition, when the conductor portion 140 is configured as a conductor wire such as a lead wire, for example, the conductor wire itself can be used, so additional processing becomes unnecessary and material costs can be reduced.

An example of a manufacturing method of the multilayer ceramic capacitor 10 according to the second example embodiment is the same or substantially the same as the multilayer ceramic capacitor 10 according to the first example embodiment, so the description thereof is omitted.

The conductor portion 140 is attached to the multilayer ceramic capacitor 10 manufactured by the same or substantially the same method as the multilayer ceramic capacitor according to the first example embodiment.

First, the conductor portion 140 is prepared. The conductor portion 140 is prepared as, for example, a conductor such as a lead wire as a metal terminal. Then, the first terminal bonding portion 142a of the conductor portion 140 and the first external electrode 30a are connected by, for example, solder or welding, and the second terminal bonding portion 142b of the conductor portion 140 and the second external electrode 30b are connected by, for example, solder or welding.

The multilayer ceramic electronic component 200 shown in FIG. 19 is manufactured in the above manner.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a multilayer ceramic capacitor including a multilayer body including a plurality of dielectric layers that are laminated, a first main surface and a second main surface opposed to each other in a lamination direction, a first lateral surface and a second lateral surface opposed to each other in a width direction orthogonal to the lamination direction, a first end surface and a second end surface opposed to each other in a length direction orthogonal or substantially orthogonal to the lamination direction and the width direction, first internal electrode layers each exposed at the first end surface and the second end surface, and second internal electrode layers each exposed at the first lateral surface and the second lateral surface;
a first external electrode and a second external electrode connected to the first internal electrode layers;
a third external electrode and a fourth external electrode connected to the second internal electrode layers; and
a conductor portion electrically connected to the first external electrode and the second external electrode, and not electrically connected to the third external electrode and the fourth external electrode; wherein
a DC resistance of the conductor portion is smaller than a DC resistance of the multilayer ceramic capacitor; and
the conductor portion includes a lead frame.

2. The multilayer ceramic electronic component according to claim 1, wherein a distance in the lamination direction between the conductor portion and the first main surface is greater than a thickness in the lamination direction of the third external electrode and the fourth external electrode provided on the first main surface.

3. The multilayer ceramic electronic component according to claim 1, wherein a thickness of each of the plurality of dielectric layers is about 0.5 μm or more and about 15 μm or less.

4. The multilayer ceramic electronic component according to claim 1, wherein each of the plurality of dielectric layers includes BaTiO₃, CaTiO3, SrTiO₃, or CaZrO₃ as a main component.

5. The multilayer ceramic electronic component according to claim 4, wherein each of the plurality of dielectric layers includes a Mn compound, a Fe compound, a Cr compound, a Co compound, or a Ni compound.

6. The multilayer ceramic electronic component according to claim 1, wherein each of the plurality of dielectric layers includes crystal grains including a perovskite compound including BaTiO₃.

7. The multilayer ceramic electronic component according to claim 6, wherein a crystal grain size of the crystal grains is about 1 μm or less.

8. The multilayer ceramic electronic component according to claim 1, wherein each of the first and second internal electrode layers includes Ni, Cu, Ag, Pd, or Au, or alloys including at least one of Ni, Cu, Ag, Pd, or Au.

9. The multilayer ceramic electronic component according to claim 1, wherein a thickness of each of the first and second internal electrode layers is about 0.5 μm or more and about 1.5 μm or less.

10. The multilayer ceramic electronic component according to claim 1, wherein each of the first, second, third, and fourth external electrodes includes a base electrode layer and a plated layer on the base electrode layer.

11. A multilayer ceramic electronic component comprising:
a multilayer ceramic capacitor including a multilayer body including a plurality of dielectric layers that are laminated, a first main surface and a second main surface opposed to each other in a lamination direction, a first lateral surface and a second lateral surface opposed to each other in a width direction orthogonal or substantially orthogonal to the lamination direction, a first end surface and a second end surface opposed to each other in a length direction orthogonal or substantially orthogonal to the lamination direction and the width direction, first internal electrode layers each exposed at the first end surface and the second end surface, and second internal electrode layers each exposed at the first lateral surface and the second lateral surface;
a first external electrode and a second external electrode connected to the first internal electrode layers;
a third external electrode and a fourth external electrode connected to the second internal electrode layers; and
a conductor portion electrically connected to the first external electrode and the second external electrode, and not electrically connected to the third external electrode and the fourth external electrode; wherein
a DC resistance of the conductor portion is smaller than a DC resistance of the multilayer ceramic capacitor; and
the conductor portion is a metal terminal.

12. The multilayer ceramic electronic component according to claim 11, wherein a distance between the conductor portion and the third external electrode or the fourth external electrode is about 10 μm or more.

13. The multilayer ceramic electronic component according to claim 11, wherein a thickness of each of the plurality of dielectric layers is about 0.5 μm or more and about 15 μm or less.

14. The multilayer ceramic electronic component according to claim 11, wherein each of the plurality of dielectric layers includes BaTiO₃, CaTiO3, SrTiO₃, or CaZrO₃ as a main component.

15. The multilayer ceramic electronic component according to claim 14, wherein each of the plurality of dielectric layers includes a Mn compound, a Fe compound, a Cr compound, a Co compound, or a Ni compound.

16. The multilayer ceramic electronic component according to claim 11, wherein each of the plurality of dielectric layers includes crystal grains including a perovskite compound including BaTiO₃.

17. The multilayer ceramic electronic component according to claim 16, wherein a crystal grain size of the crystal grains is about 1 μm or less.

18. The multilayer ceramic electronic component according to claim 11, wherein each of the first and second internal electrode layers includes Ni, Cu, Ag, Pd, or Au, or alloys including at least one of Ni, Cu, Ag, Pd, or Au.

19. The multilayer ceramic electronic component according to claim 11, wherein a thickness of each of the first and second internal electrode layers is about 0.5 μm or more and about 1.5 μm or less.

20. The multilayer ceramic electronic component according to claim 11, wherein each of the first, second, third, and fourth external electrodes includes a base electrode layer and a plated layer on the base electrode layer.
